(19) United States
(12) Patent Application Publication
(10) Pub. No.: US 2020/0291243 A1
(43) Pub. Date: Sep. 17, 2020

(54) POWDER COATING MATERIAL, COATED PRODUCT, AND WRITING BOARD

(71) Applicant: FUJI XEROX CO., LTD., Tokyo (JP)

(72) Inventors: Hiroshi SAEGUSA, Kanagawa (JP); Kiyohiro YAMANAKA, Kanagawa (JP); Hirofumi SHIOZAKI, Kanagawa (JP); Yoichiro EMURA, Kanagawa (JP)

(73) Assignee: FUJI XEROX CO., LTD., TOKYO (JP)

(21) Appl. No.: 16/519,001

(22) Filed: Jul. 23, 2019

(30) Foreign Application Priority Data
Mar. 15, 2019 (JP) 2019-048086

(51) Int. Cl. C09D 5/03; C09D 175/14; C08G 18/62; C08G 18/80; C08K 3/22; B43L 1/00

(52) U.S. Cl. CPC C09D 5/035; C09D 175/14; C08G 18/6229; C08K 2003/2241; C08K 3/22; B43L 1/002; C08G 18/80

(57) ABSTRACT

A powder coating material contains an acrylic resin that has a side chain having an alkyl group having 4 or more carbon atoms and a hydroxy group; and a curing agent.

### CROSS-REFERENCE TO RELATED APPLICATIONS

This application is based on and claims priority under 35 USC 119 from Japanese Patent Application No. 2019-048086 filed Mar. 15, 2019.

### BACKGROUND

### (i) Technical Field

The present invention relates to a powder coating material, a coated product, and a writing board.

### (ii) Related Art

Recently, in a powder coating technology using a powder coating material, a discharge amount of a volatile organic compound (VOC) is reduced in a coating step, and a powder coating material which has not been attached to an object to be coated is collected after coating and is able to be reused, and thus, the powder coating technology has attracted attention from the viewpoint of the global environment. For this reason, various powder coating materials have been studied.

In addition, as projection screens, decorative sheets, or interior wall materials for indoor room of the related art, those disclosed in JP2013-235149A, JP2012-213933A, and JP1996-253988A (Alias: JP H08-253988A) are known.

JP2013-235149A discloses a projection screen including a substrate, and a coated film layer formed on a surface of the substrate, in which the coated film layer contains a binder resin, a plurality of particles, and a surface conditioner, the surface conditioner contains a silicon-based polymer having at least an acrylic group, an exposed surface on a side opposite to a surface in contact with the substrate of the coated film layer is formed in an uneven shape due to the plurality of particles.

JP2012-213933A discloses a decorative sheet including a film substrate, and a surface protective layer formed of a cross-linked cured product of an ionizing radiation curable resin composition, in which (1) the surface protective layer contains a resin having an acrylic skeleton as a leveling agent at a ratio of 0.1 to 4.0 parts by mass with respect to 100 parts by mass of the ionizing radiation curable resin composition, and (2) as a structural unit of the resin which has an acrylic skeleton, a poly (meth)acrylate that contains (meth)acrylic acid alkyl ester having no hydroxy group, and contains at least one kind selected from (meth)acrylic acid hydroxyalkyl ester and an aromatic vinyl compound is used.

JP1996-253988A (Alias: JP H08-253988A) discloses an interior wall material for indoor rooms which has a lighting board function and which is excellent in contamination resistance, projection performance, and antiglare properties, in which an oligo (meth)acrylate which is obtained by esterifying three components of tetrahydrophthalic acid, trimethylolpropane or pentaerythritol, and a (meth)acrylic acid, which contains two or more (meth)acryloyl groups in one molecule, and which has an equivalent amount of a (meth)acryloyl group of 500 or less, is used as a first component; one kind of a polyhydric alcohol methacrylate which is selected from ethylene glycol dimethacrylate, diethylene glycol dimethacrylate, and trimethylolpropane trimethacrylate, which contains two or more methacryloyl groups in one molecule, and which has an equivalent amount of a methacryloyl group of 121 or less, is used as a second component; a blending ratio of the first component to the second component is: first component/second component=1/0.5 to 1/2 (weight ratio); an object to be coated is coated with a coating material formed by adding 1 to 40 parts by mass of glass powder having a volume of 6.5×10⁴ μm³ or less as a third component, and 1 to 20 parts by mass of an aluminum powder and/or a stainless steel powder with a radius of 1 to 50 μm as a fourth component to a total of 100 parts by mass of these components; and in a coated layer formed by curing the object to be coated by electron beam irradiation in an atmosphere where an oxygen concentration is 1% or less, an interior wall material for indoor rooms is formed by forming the coated layer on any of a metal plate, hardboard, particle board, wood plate such as wood, asbestos plate, rock wool plate, mineral plate such as gypsum plate, and plastic plate.

### SUMMARY

Aspects of non-limiting embodiments of the present disclosure relate to a powder coating material that is excellent in the moistness of a surface of a coated film obtained as compared with a case in which a powder coating material contains only an acrylic resin that has a side chain having an alkyl group having less than 4 carbon atoms and a hydroxy group.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a powder coating material containing: an acrylic resin that has a side chain having an alkyl group having 4 or more carbon atoms and a hydroxy group; and a curing agent.

### DETAILED DESCRIPTION

The present exemplary embodiment will be described will be described below. These descriptions and examples illustrate an exemplary embodiment and do not limit the scope of the exemplary embodiment.

A numerical value range shown using “to” in the present exemplary embodiment indicates a range including numerical values described before and after “to” as the minimum value and the maximum value, respectively.

In a numerical value range described stepwise in the present exemplary embodiment, an upper limit or a lower limit described in one numerical value range may be replaced with an upper limit or a lower limit of another numerical value range described stepwise. In addition, in a numerical value range described in the present exemplary embodiment, an upper limit value or a lower limit value of the numerical value range may be replaced with values shown in Example.

In the present exemplary embodiment, the term “step” is not limited to an independent step, and is included in the terms of the present exemplary embodiment as long as the intended purpose of the step is achieved even in a case where the step cannot be distinguished clearly from other steps.

In a case where the exemplary embodiment is described with reference to the drawings in the present exemplary embodiment, a configuration of the exemplary embodiment is not limited to a configuration shown in the drawings. Furthermore, sizes of members in the respective drawings are conceptual, and a relative relationship between the sizes of the members is not limited thereto.

In the present specification, “(meth)acrylate” represents both or any one of acrylate and methacrylate, “(meth)acrylic” represents both or any one of acrylic and methacryl, and “(meth)acryloyl” represents both or any one of acryloyl and methacryloyl.

In the present exemplary embodiment, each component may contain a plurality of corresponding substances. In a case of referring to an amount of each component in a composition in the present exemplary embodiment, this means a total amount of a plurality of types of substances present in the composition unless otherwise specified in a case where the plurality of types of substances corresponding to each component are present in the composition.

Powder Coating Material

A powder coating material according to the present exemplary embodiment contains an acrylic resin that has a side chain having an alkyl group having 4 or more carbon atoms and a hydroxy group, and a curing agent.

The powder coating material according to the present exemplary embodiment is preferably used as a powder coating material used for forming a writing surface of a writing board or for forming a projection surface of a projection board; is more preferably used as a powder coating material used for forming a writing surface of a writing board; and is even more preferably used as a powder coating material used for forming a writing surface of a projection writing board, although there is no particular limitation.

The powder coating material according to the present exemplary embodiment may be any one of a transparent powder coating material (clear coating material) which does not contain a colorant in powder particles, or a colored powder coating material which contains a colorant in powder particles. However, the powder coating material according to the present exemplary embodiment is, for example, preferably a clear powder coating material which does not contain a colorant in powder particles, or a white powder coating material which contains a white colorant in powder particles, from the viewpoint of an amount of change in color at the time of forming a coated film and smoothness of the obtained coated film.

In addition, the powder coating material according to the present exemplary embodiment is, for example, preferably a thermosetting powder coating material.

A coated film formed of a powder coating material of the related art has a large unevenness on a surface of the coated film and a high degree of glare of reflected light on the surface thereof. Accordingly, in some cases, it is not possible to obtain a coated film of which a surface has a moist texture (also referred to as “moistness”).

By adopting the above-described configuration, the powder coating material according to the present exemplary embodiment is excellent in the moistness of a surface of a coated film obtained. The reason for this is not clear, but is presumed to be due to the following reasons.

By using an acrylic resin that has a side chain having an alkyl group having 4 or more carbon atoms and a hydroxy group, hardness and hydrophobicity of a coated film are improved, fine control of unevenness on the surface of the coated film becomes possible, and a coated film having an appropriate balance between smoothness and an uneven shape is obtained. Therefore, the surface of the obtained coated film is excellent in moistness.

In addition, since hardness and hydrophobicity of a coated film is improved by using an acrylic resin that has a side chain having an alkyl group having 4 or more carbon atoms and a hydroxy group in the powder coating material according to the present exemplary embodiment, in a case where the powder coating material is used for forming a writing surface of a writing board, the powder coating material is also excellent in marker (specifically, a writing instrument for a white board) erasability, erasability over time after leaving words written with a marker at high temperature, and durability with respect to repetition of writing with a marker and erasing.

Hereinafter, details of the powder coating material according to the present exemplary embodiment will be described.

The powder coating material according to the present exemplary embodiment contains powder particles, and, for example, preferably contains powder particles which have an acrylic resin that has a side chain having an alkyl group having 4 or more carbon atoms and a hydroxy group, and a curing agent. If necessary, the powder coating material may have an external additive attached to a surface of the powder particles from the viewpoint of improving fluidity.

Powder Particles

Although there is no particular limitation, the powder particles preferably contain an acrylic resin that has a side chain having an alkyl group having 6 or more carbon atoms and a hydroxy group, and a curing agent.

Specific Acrylic Resin

The powder coating material according to the present exemplary embodiment contains an acrylic resin (also referred to as a “specific acrylic resin”) that has a side chain having an alkyl group having 4 or more carbon atoms and a hydroxy group, and, for example, preferably contains powder particles containing the specific acrylic resin.

The specific acrylic resin may be a resin obtained by polymerizing at least a (meth)acrylic compound, and although there is no particular limitation, the specific acrylic resin is preferably a resin that has 5% by mass to 100% by mass of a structural unit derived from a (meth) acrylic compound (also referred to as a “structural unit formed by a (meth)acrylic compound”), is more preferably a resin that has 10% by mass to 100% by mass of a structural unit derived from a (meth)acrylic compound, is even more preferably a resin that has 20% by mass to 100% by mass of a structural unit derived from a (meth)acrylic compound, and is particularly preferably a resin that has 30% by mass to 100% by mass of a structural unit derived from a (meth)acrylic compound.

Examples of the above-described (meth) acrylic compounds include acrylate compounds, methacrylate compounds, acrylic acid, methacrylic acid, acrylamide compounds, methacrylamide compounds, acrylonitrile compounds, and methacrylonitrile compounds.

Among them, although there is no particular limitation, the specific acrylic resin preferably has at least a structural unit derived from at least one compound selected from the group consisting of acrylate compounds, methacrylate compounds, acrylic acid, and methacrylic acid; and more preferably has a structural unit derived from at least one compound selected from the group consisting of acrylate compounds and methacrylate compounds.

The specific acrylic resin may have an alkyl group having 4 or more carbon atoms and a hydroxy group on one side chain, or may have each of an alkyl group having 4 or more carbon atoms and a hydroxy group on different side chains. However, from the viewpoint of moistness of a surface of a coated film obtained, marker erasability, erasability over time after leaving words written with a marker at high temperature, and durability with respect to repetition of writing with a marker and erasing, although there is no particular limitation, the specific acrylic resin preferably has each of them on different side chains, and more preferably has a structural unit having an alkyl group having 4 or more carbon atoms on a side chain and a structural unit having a hydroxy group on a side chain.

In addition, the structural unit having an alkyl group having 4 or more carbon atoms on a side chain and the structural unit having a hydroxy group on a side chain are, for example, preferably structural units derived from a (meth)acrylate compound.

The structural unit having an alkyl group having 4 or more carbon atoms on a side chain is, for example, preferably a structural unit represented by Formula (A).

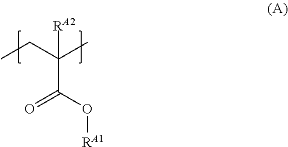

In Formula (A), R^{A1} represents an alkyl group having 4 or more carbon atoms, and R^{A2} represents a hydrogen atom or a methyl group.

Although there is no particular limitation, R^{A1} in Formula (A) is preferably an alkyl group having 6 or more carbon atoms, is more preferably an alkyl group having 6 to 20 carbon atoms, is even more preferably an alkyl group having 7 to 16 carbon atoms, and is particularly preferably an alkyl group having 8 to 12 carbon atoms, from the viewpoint of moistness of a surface of a coated film obtained, marker erasability, erasability over time after leaving words written with a marker at high temperature, and durability with respect to repetition of writing with a marker and erasing, although there is no particular limitation.

In addition, an alkyl group in R^{A1} described above may be a linear alkyl group, may be a branched alkyl group, or may be an alkyl group having a ring structure, but is, for example, preferably a linear alkyl group or a branched alkyl group.

Specific examples of R^{A1} include an n-butyl group, an n-pentyl group, an n-hexyl group, an n-heptyl group, an n-octyl group, a 2-ethylhexyl group, an n-nonyl group, an n-decyl group, an n-dodecyl group, an n-tetradecyl group, an n-hexadecyl group (a cetyl group) , an n-octadecyl group (a stearyl group) , and the like.

Among them, although there is no particular limitation, R^{A1} is preferably an n-octyl group, a 2-ethylhexyl group, an n-nonyl group, an n-decyl group, or an n-dodecyl group, and is more preferably a 2-ethylhexyl group, an n-decyl group, or an n-dodecyl group, from the viewpoint of moistness of a surface of a coated film obtained, marker erasability, erasability over time after leaving words written with a marker at high temperature, and durability with respect to repetition of writing with a marker and erasing, although there is no particular limitation.

The specific acrylic resin may have one kind of a structural unit having an alkyl group having 4 or more carbon atoms on a side chain or may have two or more kinds thereof.

Although there is no particular limitation, a content of a structural unit having an alkyl group having 4 or more carbon atoms on a side chain of the specific acrylic resin is preferably 2% by mass to 50% by mass, is more preferably 5% by mass to 40% by mass, and is particularly preferably 10% by mass to 30% by mass with respect to a total mass of the specific acrylic resin, from the viewpoint of moistness of a surface of a coated film obtained, marker erasability, erasability over time after leaving words written with a marker at high temperature, and durability with respect to repetition of writing with a marker and erasing.

In addition, although there is no particular limitation, the specific acrylic resin preferably has a hydroxyalkyl group, more preferably has a hydroxyalkyl group having 3 or more carbon atoms, more preferably has a hydroxyalkyl group having 3 to 12 carbon atoms, and particularly preferably has a hydroxyalkyl group having 4 to 8 carbon atoms, as the above-described hydroxy group, from the viewpoint of moistness of a surface of a coated film obtained, marker erasability, erasability over time after leaving words written with a marker at high temperature, and durability with respect to repetition of writing with a marker and erasing, although there is no particular limitation.

Furthermore, the above-described hydroxy group may be any of primary to tertiary hydroxy groups, but is, for example, preferably a secondary or tertiary hydroxy group, and is, for example, more preferably a secondary hydroxy group, from the viewpoint of moistness of a surface of a coated film obtained, marker erasability, erasability over time after leaving words written with a marker at high temperature, and durability with respect to repetition of writing with a marker and erasing.

Examples of ethylenically unsaturated compound having a hydroxy group used for producing the specific acrylic resin include various hydroxy group-containing (meth)acrylate compounds (for example, 2-hydroxyethyl (meth)acrylate, 2-hydroxypropyl (meth) acrylate, 3-hydroxypropyl (meth) acrylate, 2-hydroxybutyl (meth) acrylate, 3-hydroxybutyl (meth)acrylate, 4-hydroxybutyl (meth)acrylate, polyethylene glycol mono (meth) acrylate, polypropylene glycol mono(meth)acrylate, and the like), an addition reaction product of the various hydroxy group-containing (meth)acrylates and ε-caprolactone, various hydroxy group-containing vinyl ether compounds (for example, 2-hydroxyethyl vinyl ether, 3-hydroxypropyl vinyl ether, 2-hydroxypropyl vinyl ether, 4-hydroxybutyl vinyl ether, 3-hydroxybutyl vinyl ether, 2-hydroxy-2-methylpropyl vinyl ether, 5-hydroxypentyl vinyl ether, 6-hydroxyhexyl vinyl ether, and the like), an addition reaction product of the various hydroxy group-containing vinyl ethers and ε-caprolactone, various hydroxy group-containing allyl ether compounds (for example, 2-hydroxyethyl (meth)allyl ether, 3-hydroxypropyl (meth)allyl ether, 2-hydroxypropyl (meth)allyl ether, 4-hydroxybutyl (meth)allyl ether, 3-hydroxybutyl (meth)allyl ether, 2-hydroxy-2-methylpropyl (meth)allyl ether, 5-hydroxypentyl (meth)allyl ether, 6-hydroxyhexyl (meth)allyl ether, and the like), an addition reaction product of the various hydroxy group-containing allyl ethers and ε-caprolactone, and the like.

Among them, hydroxy group-containing (meth)acrylate compounds are preferable, although there is no particular limitation.

Although there is no particular limitation, the structural unit having a hydroxy group on a side chain is preferably a structural unit having a hydroxyalkyl group on a side chain, is more preferably a structural unit having a hydroxyalkyl group having 3 or more carbon atoms on a side chain, and is particularly preferably a structural unit represented by Formula (H).

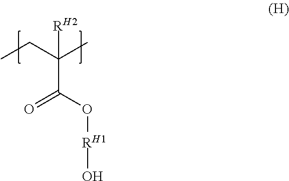

In Formula (H) , R^{H1} represents an alkylene group, and R^{H2} represents a hydrogen atom or a methyl group.

An alkylene group in R^{H1} of Formula (H) may be linear, may be branched, or may have a ring structure, but is, for example, preferably a branched alkylene group or an alkylene group having a ring structure, and is, for example, more preferably a branched alkylene group.

In addition, although there is no particular limitation, the number of carbon atoms of R^{H1} in Formula (H) is preferably 2 or more, is more preferably 3 or more, is even more preferably 3 to 12, and is particularly preferably 4 to 8, from the viewpoint of moistness of a surface of a coated film obtained, marker erasability, erasability over time after leaving words written with a marker at high temperature, and durability with respect to repetition of writing with a marker and erasing.

Furthermore, although there is no particular limitation, —R^{H1}-OH in Formula (H) is preferably a 2-hydroxyethyl group, a 2-hydroxypropyl group, a 3-hydroxypropyl group, a 2-hydroxybutyl group, a 3-hydroxybutyl group, a 4-hydroxybutyl group, a 2-hydroxypentyl group, a 5-hydroxypentyl group, a 2-hydroxyhexyl group, a 6-hydroxyhexyl group, a 2-hydroxyheptyl group, a 7-hydroxyheptyl group, a 2-hydroxyoctyl group, or a 8-hydroxyoctyl group; is more preferably a 2-hydroxypropyl group, a 2-hydroxybutyl group, a 3-hydroxybutyl group, a 2-hydroxypentyl group, a 2-hydroxyhexyl group, a 2-hydroxyheptyl group, or a 2-hydroxyoctyl group; and is particularly preferably a 2-hydroxybutyl group, from the viewpoint of moistness of a surface of a coated film obtained, marker erasability, erasability over time after leaving words written with a marker at high temperature, and durability with respect to repetition of writing with a marker and erasing.

The specific acrylic resin may have one kind of a structural unit having a hydroxy group on a side chain or may have two or more kinds thereof.

Although there is no particular limitation, a content of a structural unit having a hydroxy group on a side chain of the specific acrylic resin is preferably 2% by mass to 50% by mass, is more preferably 5% by mass to 40% by mass, and is particularly preferably 10% by mass to 30% by mass with respect to a total mass of the specific acrylic resin, from the viewpoint of moistness of a surface of a coated film obtained, marker erasability, erasability over time after leaving words written with a marker at high temperature, and durability with respect to repetition of writing with a marker and erasing.

Although there is no particular limitation, the specific acrylic resin preferably further has a structural unit having an acid group, from the viewpoint of moistness of a surface of a coated film obtained, dispersibility, and particularly dispersibility in an aqueous medium.

Examples of acid groups include a carboxy group, a sulfo group, a phosphonic acid group, a phosphoric acid group, a sulfuric acid group, and the like. Among them, for example, a carboxy group is preferable.

In addition, although there is no particular limitation, the specific acrylic resin preferably further has a structural unit represented by Formula (AC) from the viewpoint of moistness of a surface of a coated film obtained, dispersibility, and particularly dispersibility in an aqueous medium.

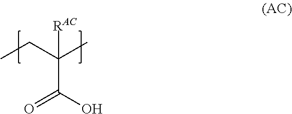

In Formula (AC), R^{AC} represents a hydrogen atom or a methyl group.

The specific acrylic resin may have one kind of a structural unit having an acid group or may have two or more kinds thereof.

Although there is no particular limitation, a content of a structural unit having an acid group of the specific acrylic resin is preferably 0.01% by mass to 10% by mass, is more preferably 0.1% by mass to 5% by mass, and is particularly preferably 0.5% by mass to 2% by mass with respect to a total mass of the specific acrylic resin, from the viewpoint of moistness of a surface of a coated film obtained, dispersibility, and particularly dispersibility in an aqueous medium.

In addition, the specific acrylic resin may be a copolymer obtained by copolymerizing a vinyl compound other than a (meth)acrylic compound.

Examples of vinyl compounds include aromatic vinyl compounds, vinyl ether compounds, vinyl ester compounds, allyl compounds, olefin compounds and the like, but aromatic vinyl compounds are preferable, styrene compounds are more preferable, and styrene is particularly preferable, although there is no particular limitation.

In other words, the specific acrylic resin is particularly preferably a styrene-acrylic copolymer, although there is no particular limitation.

Furthermore, the specific acrylic resin preferably has a structural unit represented by Formula (S), although there is no particular limitation.

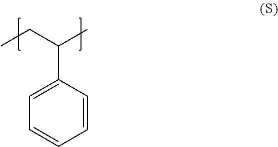

Although there is no particular limitation, a content of a structural unit represented by Formula (S) of the specific acrylic resin is preferably 10% by mass to 95% by mass, is more preferably 20% by mass to 90% by mass, and is even more preferably 30% by mass to 80% by mass, and is particularly preferably 50% by mass to 75% by mass with respect to a total mass of the specific acrylic resin, from the viewpoint of moistness of a surface of a coated film obtained, marker erasability, erasability over time after leaving words written with a marker at high temperature, and durability with respect to repetition of writing with a marker and erasing.

Although there is no particular limitation, a weight-average molecular weight of the specific acrylic resin is preferably 10,000 to 100,000, is more preferably 20,000 to 80,000, and is particularly preferably 30,000 to 70,000, from the viewpoint of moistness of a surface of a coated film obtained, marker erasability, erasability over time after leaving words written with a marker at high temperature, and durability with respect to repetition of writing with a marker and erasing.

A weight-average molecular weight (Mw) and a number average molecular weight (Mn) of the resin are measured by gel permeation chromatography (GPC). The molecular weight measurement by GPC is performed with a THF solvent using HLC-8120 GPC, which is GPC manufactured by Tosoh Corporation as a measurement device and TSKgel Super HM-M (15 cm), which is a column manufactured by Tosoh Corporation. The weight-average molecular weight and the number average molecular weight are calculated using a calibration curve of molecular weight created with a monodisperse polystyrene standard sample from results of this measurement.

The powder coating material according to the present exemplary embodiment may contain one kind of a specific acrylic resin or may contain two or more kinds thereof in combination.

In addition, the powder coating material according to the present exemplary embodiment may contain powder particles which contain only one kind of a specific acrylic resin, or may contain powder particles which contain two or more kinds of specific acrylic resins. Alternatively, powder particles in which different kinds of specific acrylic resins are contained may be used in combination.

Although there is no particular limitation, a content of the specific acrylic resin is preferably 20% by mass to 99% by mass, and is more preferably 30% by mass to 95% by mass with respect to a total mass of the powder coating material, from the viewpoint of moistness of a surface of a coated film obtained, marker erasability, erasability over time after leaving words written with a marker at high temperature, and durability with respect to repetition of writing with a marker and erasing.

In addition, although there is no particular limitation, a content of the specific acrylic resin is preferably 20% by mass to 99% by mass, and is more preferably 30% by mass to 95% by mass with respect to a total mass of powder particles, from the viewpoint of moistness of a surface of a coated film obtained, marker erasability, erasability over time after leaving words written with a marker at high temperature, and durability with respect to repetition of writing with a marker and erasing.

Curing Agent

The powder coating material according to the present exemplary embodiment contains a curing agent, and, for example, preferably contains powder particles containing the curing agent.

The curing agent is, for example, preferably a curing agent having a group that reacts with a hydroxy group of the specific acrylic resin and thus is cured.

In addition, the curing agent is, for example, preferably a thermal curing agent.

A thermal curing agent means a compound that has a functional group which can react with a hydroxy group of a specific acrylic resin by application of a heat.

Examples of thermal curing agents include various epoxy resins (for example, polyglycidyl ether of bisphenol A and the like), an epoxy group-containing acrylic resin (for example, glycidyl group-containing acrylic resin and the like), polyglycidyl ethers of various polyhydric alcohols (for example, 1,6-hexanediol, trimethylolpropane, trimethylolethane, and the like), polyglycidyl esters of various polyvalent carboxylic acids (for example, phthalic acid, terephthalic acid, isophthalic acid, hexahydrophthalic acid, methyl hexahydrophthalic acid, trimellitic acid, pyromellitic acid, and the like), various alicyclic epoxy group-containing compounds (for example, bis(3,4-epoxy cyclohexyl)methyl adipate, and the like) , hydroxy amide (for example, triglycidyl isocyanurate, β-hydroxyalkyl amide, and the like), and the like.

In addition, examples of thermal curing agents include a blocked isocyanate compound, aminoplast, and the like.

Examples of blocked isocyanate compounds include organic diisocyanates such as various aliphatic diisocyanates (for example, hexamethylene diisocyanate, trimethyl hexamethylene diisocyanate, and the like), various alicyclic diisocyanates (for example, xylylene diisocyanate, isophorone diisocyanate, and the like), and various aromatic diisocyanates (for example, tolylene diisocyanate, 4,4′-diphenylmethane diisocyanate, and the like); an adduct of these organic diisocyanates, and polyhydric alcohol, a low-molecular weight polyester resin (for example, polyester polyol) , water, or the like; a polymer of these organic diisocyanates (a polymer including an isocyanurate-type polyisocyanate compound) ; a compound obtained by blocking various polyisocyanate compounds such as an isocyanate biuret product by a commonly used blocking agent; a self-blocked polyisocyanate compound having a uretdione bond as a structural unit; and the like.

Among them, as a curing agent, for example, a blocked isocyanate compound is preferable, and for example, a blocked polyisocyanate compound is more preferable, from the viewpoint of moistness of a surface of a coated film obtained, marker erasability, erasability over time after leaving words written with a marker at high temperature, and durability with respect to repetition of writing with a marker and erasing.

The powder coating material according to the present exemplary embodiment may contain one kind of a curing agent or may contain two or more kinds thereof in combination.

In addition, the powder coating material according to the present exemplary embodiment may contain powder particles which contain only one kind of a curing agent, or may contain powder particles which contain two or more kinds of curing agents. Alternatively, powder particles in which different kinds of curing agents are contained may be used in combination.

A content of the curing agent is, for example, preferably 1% by mass to 30% by mass, and is more preferably 3% by mass to 20% by mass with respect to a content of a specific acrylic resin.

Curing Catalyst

Although there is no particular limitation, the powder coating material according to the present exemplary embodiment preferably contains a curing catalyst in the powder particles, and more preferably contains a curing catalyst in a core part of the powder particles, from the viewpoint of a curing temperature and color changes at the time of film formation.

The curing catalyst is not particularly limited, but is preferably at least one compound selected from the group consisting of metal acetylacetonate and quaternary ammonium salts. Incorporation of the at least one compound particularly reduces a decomposition temperature of the thermal curing agent having a uretdione structure.

Specific examples of metal acetylacetonates include aluminum acetylacetonate, chromium acetylacetonate, iron (III) acetylacetonate, zinc (II) acetylacetonate, zirconium (IV) acetylacetonate, and nickel (II)) acetylacetonate.

As a quaternary ammonium salt, although there is no particular limitation, tetraalkyl ammonium salts are preferable; a compound selected from the group consisting of tetraethylammonium salts and tetrabutylammonium salts is more preferable; and a compound selected from the group consisting of tetraethyl ammonium carboxylate, tetraethyl ammonium chloride, tetraethyl ammonium bromide, tetraethyl ammonium fluoride, tetrabutyl ammonium carboxylate, tetrabutyl ammonium chloride, tetrabutyl ammonium bromide, and tetrabutyl ammonium fluoride is even more preferable.

Among them, as the curing catalyst, a compound selected from the group consisting of tetraethylammonium carboxylate and tetrabutylammonium carboxylate is particularly preferable, for example.

The curing catalyst may be used alone or in combination of two or more kinds thereof.

A content of the curing catalyst, for example, preferably, a total content of the metal acetylacetonate and the quaternary ammonium salts, is not limited and is preferably 0.05% by mass to 10% by mass, and is more preferably 0.1% by mass to 5% by mass with respect to a total mass of powder particles. In a case where a content of the curing catalyst is within the above range, changes in color at the time of formation of a coated film becomes smaller.

Colorant

The powder coating material according to the exemplary embodiment of the present disclosure may contain a colorant, but preferably does not contain a colorant or contains a white colorant, although there is no particular limitation.

In addition, the powder particles may contain a colorant, but preferably do not contain a colorant or contain a white colorant, although there is no particular limitation.

Examples of colorants include pigments. The colorant may use a dye together with a pigment.

Examples of pigments include an inorganic pigment such as iron oxide (for example, colcothar), titanium oxide, titanium yellow, zinc white, white lead, zinc sulfide, lithopone, antimony oxide, cobalt blue, and carbon black; an organic pigment such as quinacridone red, phthalocyanine blue, phthalocyanine green, permanent red, Hansa yellow, indanthrene Blue, Brilliant Fast Scarlet, and benzimidazolone yellow; and the like.

Other examples of pigments include a glitter pigment. Examples of glitter pigments include metal powder such as a pearl pigment, aluminum powder, and stainless steel powder; metallic flakes; glass beads; glass flakes; mica; micaceous iron oxide (MIO); and the like.

The colorant may be used alone or in combination of two or more kinds thereof.

A content of the colorant is determined depending on types of pigments, and a hue, brightness, and depth required for a coating film, and the like. A content of the colorant is, for example, preferably 1% by mass to 70% by mass and is more preferably 2% by mass to 60% by mass, with respect to the entire resin of a core part and a resin-coated part.

Other Additives

Examples of other additives include various additives used in a powder coating material. Specific examples of other additives include a surface adjusting agent (a silicone oil, an acrylic oligomer, and the like), a foam inhibitor (for example, benzoin, benzoin derivatives, and the like), a hardening accelerator (an amine compound, an imidazole compound, a cationic polymerization catalyst, and the like), a plasticizer, a charge-controlling agent, an antioxidant, a pigment dispersant, a flame retardant, a fluidity-imparting agent, and the like.

In addition, a resin other than the specific acrylic resin may be contained as other additives. Although there is no particular limitation, a content thereof is preferably less than a content of the specific acrylic resin, is more preferably 20 mass parts by mass or less with respect to 100 parts by mass of the content of the specific acrylic resin, is even more preferably 10 mass parts by mass or less with respect to 100 parts by mass of the content of the specific acrylic resin, and is particularly preferably 5 mass parts by mass or less with respect to 100 parts by mass of the content of the specific acrylic resin.

Other Components of Powder Particles

The powder particles may contain a metal that can be a divalent or higher valent ion (hereinafter, also simply referred to as a “metal ion”). This metal ion is a component contained in both of the core part and the resin-coated part of the powder particles. In a case where a divalent or higher valent metal ion is contained in the powder particles, ionic crosslinking is formed due to the metal ion in the powder particles. For example, in a case where a polyester resin is applied as a thermosetting resin of the core part and a resin of the resin-coated part, a carboxyl group or hydroxy group of the polyester resin interacts with the metal ion to form ionic crosslinking. This ionic crosslinking suppresses bleeding of the powder particles, and storage properties are likely to be improved. In addition, regarding this ionic crosslinking, bonding of the ionic crosslinking is broken by heating at the time of thermal curing after coating of the powder coating material, and therefore melt viscosity of the powder particles is lowered, and a coating film having high smoothness is easily formed.

Examples of metal ions include divalent to tetravalent metal ions. Specific examples of metal ions include at least one kind of metal ions selected from the group consisting of aluminum ion, magnesium ion, iron ion, zinc ion, and calcium ion.

Examples of supply sources of the metal ion (a compound contained in the powder particles as an additive) include a metal salt, an inorganic metal salt polymer, a metal complex, and the like. In a case where the powder particles are produced by an aggregation and coalescence method for example, metal salts and an inorganic metal salt polymer are added to the powder particles as an aggregating agent.

Examples of metal salts include aluminum sulfate, aluminum chloride, magnesium chloride, magnesium sulfate, iron chloride (II), zinc chloride, calcium chloride, calcium sulfate, and the like.

Examples of inorganic metal salt polymers include polyaluminum chloride, polyaluminum hydroxide, polyiron sulfate (II), calcium polysulfide, and the like.

Examples of metal complexes include metal salts of an aminocarboxylic acid, and the like. Specific examples of metal complexes include metal salts (for example, calcium salts, magnesium salts, iron salts, aluminum salts, and the like) containing a known chelate as a base, such as an ethylenediaminetetraacetic acid, a propanediaminetetraacetic acid, a nitriletriacetic acid, a triethylenetetraminehexaacetic acid, and a diethylenetriaminepentaacetic acid; and the like.

A supply source of these metal ions may be added not as an aggregating agent but as a mere additive.

A higher valence of the metal ion is, for example, preferable from the viewpoint of easy formation of mesh-shaped ionic crosslinking, smoothness of a coating film, and storing properties of a powder coating material. For this reason, Al ion is, for example, preferable as the metal ion. In other words, aluminum salts (for example, aluminum sulfate, aluminum chloride, and the like) and an aluminum salt polymer (for example, polyaluminum chloride, polyaluminum hydroxide, and the like) are, for example preferable as the supply source of the metal ion. Furthermore, among the supply sources of the metal ion, an inorganic metal salt polymer is, for example, preferable as compared to metal salts even in a case of the same valence of the metal ion, from the viewpoint of smoothness of a coating film and storing properties of a powder coating material. For this reason, the aluminum salt polymer (for example, the polyaluminum chloride, the polyaluminum hydroxide, and the like) is, for example, particularly preferable as the supply source of the metal ion.

Although there is no particular limitation, a content of the metal ion is preferably 0.002% by mass to 0.2% by mass, and is more preferably 0.005% by mass to 0.15% by mass with respect to a total content of the powder particles, from the viewpoint of smoothness of a coating film and storing properties of a powder coating material.

In a case where a content of the metal ion is 0.002% by mass or more, suitable ionic crosslinking is formed due to the metal ion, bleeding of the powder particles is suppressed, and storing properties of a coating material are easily improved. On the other hand, in a case where a content of the metal ion is 0.2% by mass or less, ionic crosslinking is suppressed from being excessively formed due to the metal ion, and smoothness of a coating film is easily improved.

In a case where the powder particles are produced by an aggregation and coalescence method, the supply source of the metal ion (metal salts and a metal salt polymer) added as an aggregating agent contributes to control a particle diameter distribution and a shape of the powder particles.

Specifically, a higher valence of the metal ion is, for example, preferable from the viewpoint of obtaining a narrow particle diameter distribution. In addition, the metal salt polymer is, for example, preferable as compared to the metal salts even in a case of the same valence of the metal ion, from the viewpoint of obtaining a narrow particle diameter distribution. For this reason, from this viewpoint, although there is no particular limitation, the aluminum salts (for example, aluminum sulfate, aluminum chloride, and the like) and the aluminum salt polymer (for example, polyaluminum chloride, polyaluminum hydroxide, and the like) are preferable, and the aluminum salt polymer (for example, the polyaluminum chloride, the polyaluminum hydroxide, and the like) is particularly preferable, as the supply source of the metal ion.

In addition, in a case where an aggregating agent is added such that a content of the metal ion becomes 0.002% by mass or more, aggregation of resin particles in an aqueous medium progresses, and therefore this case contributes to realization of a narrow particle diameter distribution. In addition, aggregation of resin particles which become the resin-coated part progresses with respect to aggregated particles which become the core part, and therefore, this case contributes to realization of formation of the resin-coated part with respect to the entire surface of the core part. On the other hand, in a case where an aggregating agent is added such that a content of the metal ion becomes 0.2% by mass or less, ionic crosslinking is suppressed from being excessively generated in the aggregated particles, and a shape of the powder particles to be generated easily becomes a shape close to a spherical shape at the time of aggregation and coalescence. For this reason, from these viewpoint, although there is no particular limitation, a content of the metal ion is preferably 0.002% by mass to 0.2% mass, and is more preferably 0.005% by mass to 0.15% by mass.

A content of the metal ion is measured by performing quantitative analysis on an intensity of a fluorescent X ray of the powder particles. Specifically, for example, first, a resin and the supply source of the metal ion are mixed, and therefore a resin mixture in which a concentration of the metal ion is known is obtained. A pellet sample is obtained from 200 mg of this resin mixture by using a molding machine of a tablet having a diameter of 13 mm. A mass of this pellet sample is weighed, an intensity of a fluorescent X ray of the pellet sample is measured, and therefore a peak intensity is obtained. Similarly, measurement is performed on a pellet sample in which an amount of the supply source added of the metal ion is changed, and a calibration curve is created from the results thereof. Then, a content of the metal ions in the powder particles which are a measurement target is quantitatively analyzed by using this calibration curve.

Examples of adjustment methods of a content of the metal ion include a method 1) in which an amount of the supply source added of the metal ion is adjusted; a method 2) in which in a case where the powder particles are produced by an aggregation and coalescence method, an aggregating agent (for example, the metal salts or the metal salt polymer) is added as the supply source of the metal ion in an aggregation step, and thereafter, a chelating agent (for example, an ethylene diamine tetraacetic acid (EDTA) , a diethylene triamine pentaacetic acid (DTPA), a nitrilotriacetic acid (NTA) , and the like) is added in a final stage of the aggregation step to form a complex with the metal ion by the chelating agent, complex salts formed in the subsequent washing step or the like are removed, and therefore a content of the metal ions is adjusted; and the like.

Particles

The powder coating material according to the present exemplary embodiment preferably further contains particles, for example.

The particles may be contained in powder particles or may be an external additive. In a case where the particles are an external additive, it is possible to forma coating film having high smoothness with a small amount of the powder coating material by suppressing generation of aggregation between powder particles.

Preferably examples of particles include inorganic particles and organic resin particles, although there is no particular limitation.

Although there is no particular limitation, the powder coating material according to the present exemplary embodiment preferably further contains powder particles, and more preferably contains powder particles containing organic resin particles, from the viewpoint of erasability over time after leaving words written with a marker at high temperature, and durability with respect to repetition of writing with a marker and erasing.

The powder coating material according to the present exemplary embodiment preferably contains, for example, inorganic particles from the viewpoint of durability with respect to repetition of writing with a marker and erasing.

Examples of inorganic particles include particles such as SiO₂, TiO₂, Al₂O₃, CuO, ZnO, SnO₂, CeO₂, Fe₂O₃, MgO, BaO, CaO, K₂O, Na₂O, ZrO₂, CaO.SiO₂, K₂O.(TiO₂)ₙ, Al₂O₃.2SiO₂, CaCO₃, MgCO₃, BaSO₄, and MgSO₄.

A surface of the inorganic particles is, for example, preferably subjected to a hydrophobization treatment. The hydrophobization treatment is performed by, for example, immersing inorganic particles in a hydrophobization treatment agent. The hydrophobization treatment agent is not particularly limited, and examples thereof include a silane-based coupling agent, a silicone oil, a titanate-based coupling agent, and an aluminum-based coupling agent. These may be used alone or in combination of two or more kinds thereof .

An amount of the hydrophobization treatment agent is not limited and is preferably 1 part by mass to 10 parts by mass with respect to 100 parts by mass of the inorganic particles.

Although there is no particular limitation, the powder coating material according to the present exemplary embodiment preferably contains organic resin particles from the viewpoint of erasability over time after leaving words written with a marker at high temperature, and durability with respect to repetition of writing with a marker and erasing.

The organic resin particles are, for example, preferably organic resin particles containing a gel component from the viewpoint of durability with respect to repetition of writing with a marker and erasing.

Although there is no particular limitation, the organic resin particles preferably contain 2% by mass or more of a gel component, more preferably contain 2% by mass to 50% by mass thereof, and even more preferably contain 5% by mass to 20% by mass thereof, from the viewpoint of durability with respect to repetition of writing with a marker and erasing.

As a method for measuring a content of a gel component, organic resin particles to be measured are put into an Erlenmeyer flask, and tetrahydrofuran (THF) heated to 45° C. is put thereinto, sealed, and allowed to stand for 24 hours. At this time, for example, it is preferable to use a constant-temperature tank capable of maintaining at 45° C. Thereafter, the entire contents of the Erlenmeyer flask are transferred to a glass tube for centrifugation, and centrifuged at a rotation speed of 20,000 rpm (revolutions per minute) at −10° C. condition for 30 minutes. After centrifugation, the entire contents are taken out and allowed to stand in a 45° C. constant-temperature tank, and then a supernatant liquid that is a THF dissolving portion is separated from a THF insoluble component at 45° C. that is a precipitate. The obtained THF insoluble component is washed with THF and dried to be quantitatively determined, and a content of the gel component is calculated.

In addition, the organic resin particles are, for example, preferably crosslinked resin particles from the viewpoint of erasability over time after leaving words written with a marker at high temperature.

A method for forming a cross-linked structure in the above-mentioned organic resin particles is not particularly limited, and examples thereof include a method for using a known cross-linking agent or the like at the time of resin production.

Among these, although there is no particular limitation, the organic resin particles are particularly preferably crosslinked resin particles having a gel component from the viewpoint of erasability over time after leaving words written with a marker at high temperature, and durability with respect to repetition of writing with a marker and erasing.

An organic resin in the above-mentioned organic resin particles is not particularly limited, and examples thereof include well-known organic resins.

Specific examples thereof include acrylic resin, epoxy resin, polyester resin, polyurethane resin, polyurea resin, polyamide resin, and the like.

Among them, acrylic resin particles are, for example, preferable as the organic resin particles.

Although there is no particular limitation, a volume average particle diameter of particles is preferably 5 nm to 1,000 nm, is more preferably 10 nm to 300 nm, is even more preferably 10 nm to 200 nm, and is particularly preferably 15 nm to 100 nm from the viewpoint of fluidity of particles.

A volume average particle diameter of particles is measured by the following method.

First, a powder coating material which is a measurement target is observed by a scanning electron microscope (SEM). Then, an equivalent circle diameter of each of 100 particles which are measurement targets is obtained by image analysis, and an equivalent circle diameter having a cumulative percentage of 50% on a volume basis is obtained as a volume average particle diameter from a small diameter side in a distribution on a volume basis.

In the image analysis for obtaining the equivalent circle diameter of 100 particles which are the measurement targets, a two-dimensional image is captured at a magnification of 10,000 times by using an analysis device (ERA-8900: manufactured by ELIONIX INC.), a projection area is obtained under conditions of 0.010000 um/pixel by using image analysis software WinROOF (manufactured by MITANI CORPORATION), and the equivalent circle diameter is obtained by expression: equivalent circle diameter=2×(projection area/n)^{1/2}.

In order to measure the volume average particle diameter of plural types of external additives from a powder coating material, it is necessary to separate each external additive. Specifically, various external additives are subjected to element mapping by using a scanning electron microscope provided with an energy dispersion type X-ray analysis device (SEM-EDX), and an element derived from various external additives is associated with the corresponding external additive, and therefore, the external additives are separated.

The powder coating material according to the present exemplary embodiment may contain one kind of particles or may contain two or more kinds thereof in combination. In addition, inorganic particles and organic resin particles may be used in combination.

Although there is no particular limitation, a content of particles is preferably 0.01% by mass to 5% by mass %, and is more preferably 0.01% by mass to 2.0% by mass % with respect to a total mass of a powder coating material.

Characteristics of Powder Particles and Powder Coating Material

Although there is no particular limitation, a volume average particle size distribution index GSDv of powder particles is preferably 1.50 or less, is more preferably 1.40 or less, and is particularly preferably 1.30 or less, from the viewpoint of smoothness of a coating film and storing properties of a powder coating material.

Although there is no particular limitation, a volume average particle diameter D₅₀ᵥ of powder particles is preferably 1 μm to 25 μm, is more preferably 2 μm to 20 μm, and is particularly preferably 3 μm to 15 μm, from the viewpoint of forming a coating film having high smoothness with a small amount of the powder coating material.

Although there is no particular limitation, an average circularity of powder particles is preferably 0.95 or more, is more preferably 0.96 or more, and is particularly preferably 0.97 or more, from the viewpoint of smoothness of a coating film and storing properties of a powder coating material.

A volume average particle diameter D₅₀ᵥ and a volume average particle size distribution index GSDv of powder particles are measured by using a COULTER Multisizer II (manufactured by Beckman Coulter, Inc.) and using ISOTON-II (manufactured by Beckman Coulter, Inc.) as an electrolyte.

In the measurement, 0.5 mg to 50 mg of a measurement sample is added to 2 ml of an aqueous solution of 5% by mass of a surfactant (for example, preferably sodium alkyl benzene sulfonate) as a dispersant. The mixture is added to 100 ml to 150 ml of the electrolyte.

The electrolyte in which the sample is suspended is subjected to a dispersion treatment using an ultrasonic disperser for 1 minute, and a particle diameter distribution of particles having a particle diameter within a range of 2 μm to 60 μm is measured with a COULTER Multisizer II by using an aperture having an aperture diameter of 100 μm. The number of particles to be sampled is 50,000.

Cumulative distributions by volume are drawn from the side of the smallest diameter with respect to particle size ranges (channels) separated based on the measured particle diameter distribution. The particle diameter when the cumulative percentage becomes 16% is defined as that corresponding to a volume average particle diameter D₁₆ᵥ while the particle diameter when the cumulative percentage becomes 50% is defined as that corresponding to a volume average particle diameter D₅₀ᵥ. Furthermore, the particle diameter when the cumulative percentage becomes 84% is defined as that corresponding to a volume average particle diameter D₈₄ᵥ.

A volume average particle size distribution index (GSDv) is calculated as (D₈₄ᵥ/D₁₆ᵥ)^{1/2}.

An average circularity of powder particles is measured by using a flow type particle image analyzer “FPIA-3000 (manufactured by Sysmex Corporation).” Specifically, 0.1 mL to 0.5 mL of a surfactant (alkyl benzene sulfonate) as a dispersant is added into 100 mL to 150 mL of water obtained by removing impurities which are solid matter in advance, and 0.1 g to 0.5 g of a measurement sample is further added thereto. A suspension in which the measurement sample is dispersed is subjected to a dispersion treatment with an ultrasonic dispersion device for 1 minute to 3 minutes, and a concentration of the dispersion liquid is 3,000 particles/μL to 10,000 particles/μL. With respect to this dispersion liquid, an average circularity of powder particles is measured by using the flow type particle image analyzer.

An average circularity of powder particles is a value obtained by obtaining a circularity (Ci) of each of n particles measured for the powder particles, and then performing calculation by the following expression. In the following expression, Ci represents a circularity (=circumference length of circle equivalent to projection area of particle/circumference length of particle projection image), and fi represents frequency of the powder particles.

$$Average circularity ( Ca ) = ( {\sum }_{i = 1}^{n} ( Ci \times fi ) ) \text{/} {\sum }_{i = 1}^{n} ( fi )$$

Although there is no particular limitation, a melting temperature in a 1/2 method of the powder coating material according to the present exemplary embodiment is preferably 90° C. to 125° C., and is more preferably 100° C. to 115° C., from the viewpoint of smoothness of a coating film and a decrease in a baking temperature.

A softening point of the powder coating material is measured by using a tubular rheometer of constant load extrusion type, “flow characteristic evaluation device Flow Tester CFT-500D” (manufactured by Shimadzu Corporation) according to a manual attached to the device. In this device, while applying a constant load from the top part of a measurement sample by a piston, the measurement sample filled in a cylinder is heated and melted, the melted measurement sample is extruded from a die at the bottom part of the cylinder, and therefore it is possible to obtain a flow curve that indicates the relationship between an amount of piston depression and a temperature at this time.

In the present embodiment, a “melting temperature in the 1/2 method” described in the manual attached to the “flow characteristic evaluation device Flow Tester CFT-500D” is taken as a softening point. A melting temperature in the 1/2 method is calculated as follows. First, 1/2 of a difference between an amount of drop Smax of the piston when outflow is completed, and an amount of drop Smin of the piston when the outflow is started is obtained (which is taken as X). X=(Smax−Smin)/2) . Then, a temperature of a flow curve when an amount of drop of the piston in the flow curve becomes a sum of X and Smin is a melting temperature Tm in the 1/2 method.

About 1.0 g of a sample is compression molded at about 10 MPa for about 60 seconds under an environment of 25° C. using a tablet molding and compression machine (for example, NT-100H, manufactured by NPa SYSTEM CO., LTD.) , and a cylindrical sample having a diameter of about 8 mm is used.

The measurement conditions of CFT-500D are as follows.

Test mode: Temperature rising method

Starting temperature: 50° C.

End-point temperature: 200° C.

Measurement interval: 1.0° C.

Heating rate: 4.0° C./min

Piston cross-sectional area: 1,000 cm²

Test load (piston load) : 10.0 kgf (0.9807 MPa)

Preheating time: 300 seconds

Hole diameter of die: 1.0 mm

Length of die: 1.0 mm

A peak temperature of an exothermic peak in differential scanning calorimetry (DSC measurement) of the powder coating material according to the present exemplary embodiment is, for example, preferably within a range of 40° C. to 100° C., and is more preferably within a range of 50° C. to 80° C., from the viewpoint of smoothness of a coating film and a decrease in a baking temperature.

The measurement of the exothermic peak in differential scanning calorimetry (DSC measurement) is performed as follows.

A sample is set on a differential scanning calorimeter (DSC-50, manufactured by Shimadzu Corporation) equipped with an automatic tangent processing system, liquid nitrogen is set as a cooling medium, and heat is performed from 0° C. to 200° C. at a heating rate of 10° C./min, and therefore a DSC curve is obtained. A peak temperature of the exothermic peak in the obtained DSC curve is obtained as a measurement value.

A melting temperature of the mixture of indium and zinc is used for temperature correction of a detection unit of the measuring device, and melting heat of indium is used for heat correction. A sample is put in an aluminum pan, the aluminum pan in which the sample is put and an empty aluminum pan for the control are set.

Method for Manufacturing Powder Coating Material

Next, a method for manufacturing the powder coating material according to the present exemplary embodiment will be described.

The powder coating material according to the present exemplary embodiment is obtained by, after manufacturing powder particles, externally adding external additives to the powder particles as necessary.

The powder particles may be manufactured by any of a dry manufacture method (for example, a kneading and pulverizing method and the like) , and a wet-type manufacture method (for example, aggregation and coalescence method, a suspension and polymerization method, a dissolution and suspension method, and the like) . The method for manufacturing powder particles is not particularly limited to these manufacture methods, and known manufacture methods are employed.

Among these, for example, it is preferable to obtain powder particles by an aggregation and coalescence method from the viewpoint of easy control of a volume average particle size distribution index GSDv and an average circularity within the above-mentioned range.

Hereinafter, the details of each of the steps will be described.

In the following description, a method for manufacturing powder particles containing a colorant will be described, but the colorant is contained therein if necessary.

Preparing Step of Each Dispersion Liquid

First, each dispersion liquid to be used in the aggregation and coalescence method is prepared. Specifically, a resin particle dispersion liquid in which specific acrylic resin particles are dispersed, a curing agent dispersion liquid in which a curing agent is dispersed, and a colorant dispersion liquid in which a colorant is dispersed are prepared.

Herein, a resin particle dispersion liquid is prepared by, for example, dispersing resin particles in a dispersion medium with a surfactant.

Examples of dispersion media used in the resin particle dispersion liquid include an aqueous medium.

Examples of aqueous media include water such as distilled water and ion exchange water; alcohols; and the like. The medium may be used alone or in combination of two or more kinds thereof.

Examples of surfactants include anionic surfactants such as sulfuric ester salt, sulfonate, phosphate ester, and soap anionic surfactants; cationic surfactants such as amine salt and quaternary ammonium salt cationic surfactants; nonionic surfactants such as polyethylene glycol, alkyl phenol ethylene oxide adduct, and polyol nonionic surfactants; and the like. Among these, anionic surfactants and cationic surfactants are particularly used. Nonionic surfactants may be used in combination with anionic surfactants or cationic surfactants.

The surfactants may be used alone or in combination of two or more kinds thereof.

Regarding the resin particle dispersion liquid, examples of methods of dispersing resin particles in a dispersion medium include a general dispersing method using, for example, a rotary shearing-type homogenizer, or a ball mill, a sand mill, or a Dyno mill having media. Depending on types of resin particles, resin particles may be dispersed in the resin particle dispersion liquid by using, for example, a phase inversion emulsification method.

The phase inversion emulsification method is a method in which resin to be dispersed is dissolved in a hydrophobic organic solvent in which the resin is soluble; neutralization is performed by adding a base to an organic continuous phase (O phase); the resin is converted (so-called phase inversion) from W/O to O/W by adding an aqueous medium (W phase) to form a discontinuous phase, and therefore the resin is dispersed as particles in the aqueous medium.

As a method for manufacturing a resin particle dispersion liquid, specifically, for example, in a case of an acrylic resin particle dispersion liquid, a resin particle dispersion liquid in which acrylic resin particles are dispersed is obtained by emulsifying a raw material monomer in water in an aqueous medium, adding a water-soluble initiator, and if necessary, a chain transfer agent for molecular weight control and heating the mixture, and performing emulsion polymerization.

In addition, in a case of a polyester resin particle dispersion liquid, a resin particle dispersion liquid in which polyester resin particles are dispersed is obtained by heating and melting a raw material monomer and by polycondensing the raw material monomer under reduced pressure, and then by adding the obtained polycondensate to a solvent (for example, ethyl acetate and the like) and by dissolving the polycondensate in the solvent, and furthermore, by stirring the obtained dissolved material while adding a weak alkaline aqueous solution thereinto, and by performing phase inversion and emulsion with respect to the dissolved material.

In a case of obtaining a composite particle dispersion liquid, the composite particle dispersion liquid is obtained by mixing a resin and a thermal curing agent and dispersing the mixture in a dispersion medium (for example, performing emulsification such as phase inversion and emulsion).

Although there is no particular limitation, a volume average particle diameter of the resin particles dispersed in the resin particle dispersion liquid is preferably 1 μm or less, is more preferably 0.01 μm to 1 μm, is even more preferably 0.08 μm to 0.8 μm, and is particularly preferably 0.1 μm to 0.6 μm.

Regarding the volume average particle diameter of the resin particles, a cumulative distribution by volume is drawn from the side of the smallest diameter with respect to particle size ranges (channels) separated using the particle diameter distribution obtained by the measurement with a laser diffraction-type particle diameter distribution measuring device (for example, LA-700 manufactured by Horiba, Ltd.), and a particle diameter when the cumulative percentage becomes 50% with respect to the entire particles is measured as a volume average particle diameter D₅₀ᵥ. The volume average particle diameter of the particles in other dispersion liquids is also measured in the same manner.

The content of the resin particles contained in the resin particle dispersion liquid is, for example, preferably from 5% by weight to 50% by weight, and more preferably from 10% by weight to 40% by weight.

For example, the curing agent dispersion liquid and the colorant dispersion liquid are also prepared in the same manner as in the case of the resin particle dispersion liquid. That is, the volume average particle diameter, the dispersion medium, the dispersing method, and the content of the particles of the colorant dispersed in the colorant dispersion liquid and the particles of the curing agent dispersed in the curing agent dispersion liquid are the same as those of the resin particles in the resin particle dispersion.

Aggregated Particle Forming Step

Next, the resin particle dispersion liquid, the curing agent dispersion liquid, and, if necessary, the colorant dispersion liquid are mixed with each other.

The specific acrylic resin particles, the curing agent, and the colorant are heterogeneously aggregated in the mixed dispersion liquid, thereby forming aggregated particles having a diameter near a target powder particle diameter and including the specific acrylic resin, the curing agent, and the colorant.

Specifically, for example, an aggregating agent is added to the mixed dispersion liquid and a pH of the mixed dispersion liquid is adjusted to be acidic (for example, the pH is from 2 to 5). If necessary, a dispersion stabilizer is added. Then, the mixed dispersion liquid is heated at a temperature of a glass transition temperature of the resin particles (specifically, for example, from a temperature 30° C. lower than the glass transition temperature of the resin particles to a temperature 10° C. lower than the glass transition temperature thereof) to aggregate the particles dispersed in the mixed dispersion liquid, thereby forming the aggregated particles.

In the aggregated particle forming step, the aggregated particles may be formed by mixing the composite particle dispersion liquid including the specific acrylic resin and the curing agent, and the colorant dispersion liquid with each other and heterogeneously aggregating the composite particles and the colorant in the mixed dispersion liquid.

In the aggregated particle forming step, for example, the aggregating agent may be added at room temperature (for example, 25° C.) while stirring of the mixed dispersion liquid using a rotary shearing-type homogenizer, the pH of the mixed dispersion liquid may be adjusted to be acidic (for example, the pH is from 2 to 5), a dispersion stabilizer may be added if necessary, and the heating may then be performed.

Examples of the aggregating agent include a surfactant having an opposite polarity to the polarity of the surfactant used as the dispersant to be added to the mixed dispersion liquid, metal salt, a metal salt polymer, and a metal complex. When a metal complex is used as the aggregating agent, the amount of the surfactant used is reduced and charging characteristics are improved.

After completing the aggregation, an additive for forming a complex or a similar bond with metal ion of the aggregating agent maybe used, if necessary. A chelating agent is used as this additive. With the addition of this chelating agent, the content of the metal ion of the powder particles may be adjusted, when the aggregating agent is excessively added.

Herein, the metal salt, the metal salt polymer, or the metal complex as the aggregating agent is used as a supply source of the metal ions. These examples are as described above.

A water-soluble chelating agent is used as the chelating agent. Specific examples of the chelating agent include oxycarboxylic acids such as tartaric acid, citric acid, and gluconic acid, iminodiacetic acid (IDA), nitrilotriacetic acid (NTA), and ethylenediaminetetraacetic acid (EDTA).

The amount of the chelating agent added may be, for example, from 0.01 parts by weight to 5.0 parts by weight, and is preferably from greater than or equal to 0.1 parts by weight and less than 3.0 parts by weight with respect to 100 parts by weight of the resin particles.

Coalescence Union Step

Next, the aggregated particle dispersion liquid in which the aggregated particles are dispersed is heated at, for example, a temperature that is higher than or equal to the glass transition temperature of the resin particles (for example, a temperature that is higher than the glass transition temperature of the resin particles by 10° C. to 30° C.) to coalesce the aggregated particles and form the powder particles.

The powder particles are obtained through the foregoing step.

Herein, after the coalescence step ends, the powder particles formed in the dispersion liquid are subjected to a washing step, a solid-liquid separation step, and a drying step, that are well known, and thus, dry powder particles are obtained.

In the washing step, for example, preferably displacement washing using ion exchange water is sufficiently performed from the viewpoint of charging properties. In addition, the solid-liquid separation step is not particularly limited, but suction filtration, pressure filtration, or the like is preferably performed from the viewpoint of productivity. The method for the drying step is also not particularly limited, but freeze drying, airflow drying, fluidized drying, vibration-type fluidized drying, or the like is preferably performed from the viewpoint of productivity.

In addition, the powder coating material according to the present exemplary embodiment is manufactured by, for example, adding and mixing external additives with the obtained powder particles in a dry state as necessary. Mixing is preferably performed with, for example, a V-BLENDER, a HENSCHEL MIXER, an LODIGE MIXER, or the like. Furthermore, if necessary, coarse particles of a toner may be removed using a vibration sieving machine, a wind classifier, or the like.

Coated Product and Method for Manufacturing Coated Product

A coated product according to the present exemplary embodiment is a coated product having a layer formed by curing the powder coating material according to the present exemplary embodiment, and is, for example, preferably a coated product having a layer formed by curing the powder coating material according to the present exemplary embodiment on an outermost layer. In addition, a method for manufacturing the coated product according to the present exemplary embodiment is a method for manufacturing the coated product which is coated with the powder coating material according to the present exemplary embodiment.

Specifically, the coated product is obtained by coating a surface to be coated with a powder coating material, and then heating (baking) the surface to form a coating film obtained by curing the powder coating material. Coating with the powder coating material and the heating (baking) may be performed collectively.

Coating with the powder coating material uses known coating methods such as electrostatic powder coating, triboelectric powder coating, fluid immersion, and the like. A thickness of a coating film of a powder coating material is, for example, preferably 30 μm to 50 μm.

Although there is no particular limitation, a heating temperature (a baking temperature) is preferably 90° C. to 250° C., is more preferably 100° C. to 220° C., and is even more preferably 120° C. to 200° C. A heating time (a baking time) is adjusted according to a heating temperature (a baking temperature).

An object to be coated with the powder coating material is not particularly limited, and examples of the object to be coated include various metal components, ceramic components, resin components, and the like. The target product may be an unmolded product before being molded into each product such as a plate-shaped product and a linear product, or may be a molded product molded for electronic components, road vehicles, interior and exterior architectural materials, and the like. In addition, the target product may be a product of which the surface to be coated is subjected to a surface treatment such as a primer treatment, a plating treatment, and electrodeposition coating.

Among them, although there is no particular limitation, a coated product is preferably a writing board or a projection board from the viewpoint of further exhibiting the effect of the present exemplary embodiment which is moistness of a surface of a coated film; and is more preferably a writing board and is particularly preferably a projection writing board from the viewpoint of further exhibiting the effect of the present exemplary embodiment which is excellence in marker erasability, erasability over time after leaving words written with a marker at high temperature, and durability with respect to repetition of writing with a marker and erasing.

More specifically, although there is no particular limitation, a writing board or a projection board according to the present exemplary embodiment is preferably a writing board or a projection board having a layer formed by curing the powder coating material on an outermost layer, and a projection writing board according to the present exemplary embodiment is preferably a projection writing board having a layer formed by curing the powder coating material on an outermost layer.

Furthermore, a layer formed by curing the powder coating material according to the present exemplary embodiment which is in the coated product according to the present exemplary embodiment is, for example, preferably a colorless and transparent layer (a clear layer) or a white layer.

The term “colorless and transparent” in the present exemplary embodiment means that a transmittance of light with a wavelength of 400 nm to 750 nm is 80% or more.

### EXAMPLES

Hereinafter, the present exemplary embodiment will be described in detail with reference to examples, and the present exemplary embodiment is not limited to the examples. Furthermore, in the following description, unless otherwise particularly stated, both of “parts” and “%” are based on a mass.

In addition, the measurement of an amount of metal ions in a powder coating material is performed by the method described above.

Preparation of White Pigment Dispersion Liquid (W1)

Titanium oxide (A-220 manufactured by ISHIHARA SANGYO KAISHA, LTD.): 200 parts by mass
Anionic surfactant (NEOGEN RK manufactured by DKS Co. Ltd.): 30 parts by mass
Ion exchange water: 290 parts by mass

0.3 mol/L of nitric acid: 9 parts by mass or more

The components described above are mixed, dissolved, and are dispersed for 3 hours by using a high pressure impact type disperser ULTIMIZER (HJP30006, manufactured by SUGINO MACHINE LIMITED), and therefore, a white pigment dispersion liquid formed by dispersing titanium oxide is prepared. Measurement is performed by using a laser diffraction particle diameter measurement machine. A volume average particle diameter of the titanium oxide in the pigment dispersion liquid is 0.25 pm, and a solid content ratio of the white pigment dispersion liquid is 40%.

Preparation of Acrylic Resin Dispersion Liquid (A1)

Styrene: 390 parts by mass

n-Butyl acrylate: 97 parts by mass

2-Hydroxybutyl methacrylate: 104 parts by mass

Acrylic acid: 8.5 parts by mass

Dodecanethiol: 3.9 parts by mass

The above components are mixed and dissolved to prepare a solution. Meanwhile, 10 parts by mass of an anionic surfactant (DOWFAX, manufactured by The Dow Chemical Company) is dissolved in 220 parts by mass of ion exchange water, the above solution is added thereto, and the mixture is dispersed in a flask and emulsified to prepare a solution (monomer emulsified liquid A).

In addition, similarly, 1 part by mass of an anionic surfactant (DOWFAX, manufactured by The Dow Chemical Company) is dissolved in 476 parts by mass of ion exchange water, and charged into a polymerization flask.

The polymerization flask is tightly sealed, a recirculating pipe is installed, and the polymerization flask is heated to 75° C. with a water bath and maintained while introducing nitrogen and while slowly stirring. 9 parts by mass of ammonium persulfate is dissolved in 37 parts by mass of ion exchange water and added dropwise into the polymerization flask through a metering pump over 20 minutes, and thereafter, the monomer emulsified liquid A is also added dropwise thereinto through a metering pump over 200 minutes. Thereafter, the polymerization flask is maintained at 75° C. for 3 hours while stirring is continued slowly to complete the polymerization.

Accordingly, a resin particle dispersion liquid (A1) in which a particle diameter is 230 nm, a glass transition point is 54° C., a weight-average molecular weight is 51,000, and a solid content is 45% is obtained.

Preparation of Acrylic Resin Dispersion Liquid (A2)

Styrene: 362 parts by mass

n-Butyl acrylate: 91 parts by mass

2-Hydroxybutyl methacrylate: 137 parts by mass

Acrylic acid: 8.8 parts by mass

Dodecanethiol: 3.8 parts by mass

The above components are mixed and dissolved to prepare a solution. Meanwhile, 10 parts by mass of an anionic surfactant (DOWFAX, manufactured by The Dow Chemical Company) is dissolved in 220 parts by mass of ion exchange water, the above solution is added thereto, and the mixture is dispersed in a flask and emulsified to prepare a solution (monomer emulsified liquid A).

In addition, similarly, 1 part by mass of an anionic surfactant (DOWFAX, manufactured by The Dow Chemical Company) is dissolved in 476 parts by mass of ion exchange water, and charged into a polymerization flask.

The polymerization flask is tightly sealed, a recirculating pipe is installed, and the polymerization flask is heated to 75° C. with a water bath and maintained while introducing nitrogen and while slowly stirring. 9 parts by mass of ammonium persulfate is dissolved in 37 parts by mass of ion exchange water and added dropwise into the polymerization flask through a metering pump over 20 minutes, and thereafter, the monomer emulsified liquid A is also added dropwise thereinto through a metering pump over 200 minutes. Thereafter, the polymerization flask is maintained at 75° C. for 3 hours while stirring is continued slowly to complete the polymerization.

Accordingly, a resin particle dispersion liquid (A2) in which a particle diameter is 220 nm, a glass transition point is 55° C., a weight-average molecular weight is 52,000, and a solid content is 45% is obtained.

Preparation of Acrylic Resin Dispersion Liquid (A3)

Styrene: 242 parts by mass

n-Butyl acrylate: 46 parts by mass

2-Hydroxybutyl methacrylate: 303 parts by mass

Acrylic acid: 8.5 parts by mass

Dodecanethiol: 3.7 parts by mass

The above components are mixed and dissolved to prepare a solution. Meanwhile, 10 parts by mass of an anionic surfactant (DOWFAX, manufactured by The Dow Chemical Company) is dissolved in 220 parts by mass of ion exchange water, the above solution is added thereto, and the mixture is dispersed in a flask and emulsified to prepare a solution (monomer emulsified liquid A).

In addition, similarly, 1 part by mass of an anionic surfactant (DOWFAX, manufactured by The Dow Chemical Company) is dissolved in 476 parts by mass of ion exchange water, and charged into a polymerization flask.

The polymerization flask is tightly sealed, a recirculating pipe is installed, and the polymerization flask is heated to 75° C. with a water bath and maintained while introducing nitrogen and while slowly stirring. 9 parts by mass of ammonium persulfate is dissolved in 37 parts by mass of ion exchange water and added dropwise into the polymerization flask through a metering pump over 20 minutes, and thereafter, the monomer emulsified liquid A is also added dropwise thereinto through a metering pump over 200 minutes. Thereafter, the polymerization flask is maintained at 75° C. for 3 hours while stirring is continued slowly to complete the polymerization.

Accordingly, a resin particle dispersion liquid (A3) in which a particle diameter is 230 nm, a glass transition point is 60° C., a weight-average molecular weight is 55,000, and a solid content is 45% is obtained.

Preparation of Acrylic Resin Dispersion Liquid (A4)

Styrene: 256 parts by mass

2-Ethylhexyl methacrylate: 135 parts by mass

2-Hydroxybutyl methacrylate: 201 parts by mass

Acrylic acid: 8.8 parts by mass

Dodecanethiol: 5.0 parts by mass

The above components are mixed and dissolved to prepare a solution. Meanwhile, 10 parts by mass of an anionic surfactant (DOWFAX, manufactured by The Dow Chemical Company) is dissolved in 220 parts by mass of ion exchange water, the above solution is added thereto, and the mixture is dispersed in a flask and emulsified to prepare a solution (monomer emulsified liquid A).

In addition, similarly, 1 part by mass of an anionic surfactant (DOWFAX, manufactured by The Dow Chemical Company) is dissolved in 476 parts by mass of ion exchange water, and charged into a polymerization flask.

The polymerization flask is tightly sealed, a recirculating pipe is installed, and the polymerization flask is heated to 75° C. with a water bath and maintained while introducing nitrogen and while slowly stirring. 9 parts by mass of ammonium persulfate is dissolved in 37 parts by mass of ion exchange water and added dropwise into the polymerization flask through a metering pump over 20 minutes, and thereafter, the monomer emulsified liquid A is also added dropwise thereinto through a metering pump over 200 minutes. Thereafter, the polymerization flask is maintained at 75° C. for 3 hours while stirring is continued slowly to complete the polymerization.

Accordingly, a resin particle dispersion liquid (A4) in which a particle diameter is 220 nm, a glass transition point is 54° C., a weight-average molecular weight is 40,000, and a solid content is 45% is obtained.

Preparation of Acrylic Resin Dispersion Liquid (A5)

Styrene: 296 parts by mass

2-Ethylhexyl methacrylate: 140 parts by mass

2-Hydroxypropyl methacrylate: 155 parts by mass

Acrylic acid: 8.9 parts by mass

Dodecanethiol: 5.3 parts by mass

The above components are mixed and dissolved to prepare a solution. Meanwhile, 10 parts by mass of an anionic surfactant (DOWFAX, manufactured by The Dow Chemical Company) is dissolved in 220 parts by mass of ion exchange water, the above solution is added thereto, and the mixture is dispersed in a flask and emulsified to prepare a solution (monomer emulsified liquid A).

In addition, similarly, 1 part by mass of an anionic surfactant (DOWFAX, manufactured by The Dow Chemical Company) is dissolved in 476 parts by mass of ion exchange water, and charged into a polymerization flask.

The polymerization flask is tightly sealed, a recirculating pipe is installed, and the polymerization flask is heated to 75° C. with a water bath and maintained while introducing nitrogen and while slowly stirring. 9 parts by mass of ammonium persulfate is dissolved in 37 parts by mass of ion exchange water and added dropwise into the polymerization flask through a metering pump over 20 minutes, and thereafter, the monomer emulsified liquid A is also added dropwise thereinto through a metering pump over 200 minutes. Thereafter, the polymerization flask is maintained at 75° C. for 3 hours while stirring is continued slowly to complete the polymerization.

Accordingly, a resin particle dispersion liquid (A5) in which a particle diameter is 220 nm, a glass transition point is 53° C., a weight-average molecular weight is 40,000, and a solid content is 45% is obtained.

Preparation of Acrylic Resin Dispersion Liquid (A6)

Styrene: 290 parts by mass

Dodecyl methacrylate: 99 parts by mass

2-Hydroxybutyl methacrylate: 202 parts by mass

Acrylic acid: 8.6 parts by mass

Dodecanethiol: 5.1 parts by mass

The above components are mixed and dissolved to prepare a solution. Meanwhile, 10 parts by mass of an anionic surfactant (DOWFAX, manufactured by The Dow Chemical Company) is dissolved in 220 parts by mass of ion exchange water, the above solution is added thereto, and the mixture is dispersed in a flask and emulsified to prepare a solution (monomer emulsified liquid A).

In addition, similarly, 1 part by mass of an anionic surfactant (DOWFAX, manufactured by The Dow Chemical Company) is dissolved in 476 parts by mass of ion exchange water, and charged into a polymerization flask.

The polymerization flask is tightly sealed, a recirculating pipe is installed, and the polymerization flask is heated to 75° C. with a water bath and maintained while introducing nitrogen and while slowly stirring. 9 parts by mass of ammonium persulfate is dissolved in 37 parts by mass of ion exchange water and added dropwise into the polymerization flask through a metering pump over 20 minutes, and thereafter, the monomer emulsified liquid A is also added dropwise thereinto through a metering pump over 200 minutes. Thereafter, the polymerization flask is maintained at 75° C. for 3 hours while stirring is continued slowly to complete the polymerization.

Accordingly, a resin particle dispersion liquid (A6) in which a particle diameter is 230 nm, a glass transition point is 52° C., a weight-average molecular weight is 40,000, and a solid content is 45% is obtained.

Preparation of Acrylic Resin Dispersion Liquid (A7)

Styrene: 331 parts by mass

Dodecyl methacrylate: 104 parts by mass

2-Hydroxypropyl methacrylate: 156 parts by mass

Acrylic acid: 9.0 parts by mass

Dodecanethiol: 5.3 parts by mass

The above components are mixed and dissolved to prepare a solution. Meanwhile, 10 parts by mass of an anionic surfactant (DOWFAX, manufactured by The Dow Chemical Company) is dissolved in 220 parts by mass of ion exchange water, the above solution is added thereto, and the mixture is dispersed in a flask and emulsified to prepare a solution (monomer emulsified liquid A).

In addition, similarly, 1 part by mass of an anionic surfactant (DOWFAX, manufactured by The Dow Chemical Company) is dissolved in 476 parts by mass of ion exchange water, and charged into a polymerization flask.

The polymerization flask is tightly sealed, a recirculating pipe is installed, and the polymerization flask is heated to 75° C. with a water bath and maintained while introducing nitrogen and while slowly stirring. 9 parts by mass of ammonium persulfate is dissolved in 37 parts by mass of ion exchange water and added dropwise into the polymerization flask through a metering pump over 20 minutes, and thereafter, the monomer emulsified liquid A is also added dropwise thereinto through a metering pump over 200 minutes. Thereafter, the polymerization flask is maintained at 75° C. for 3 hours while stirring is continued slowly to complete the polymerization.

Accordingly, a resin particle dispersion liquid (A7) in which a particle diameter is 230 nm, a glass transition point is 52° C., a weight-average molecular weight is 40,000, and a solid content is 45% is obtained.

Preparation of Curing Agent Dispersion Liquid (B1)

Blocked isocyanate curing agent VESTAGONB1530 (manufactured by Evonik Japan Co., Ltd.): 150 parts by mass

Anionic surfactant (sodium dodecylbenzenesulfonate): 1 part by mass
Ion exchange water: 350 parts by mass

The components described above are mixed, dissolved, and are dispersed for 3 hours by using a high pressure impact type disperser ULTIMIZER (HJP30006, manufactured by SUGINO MACHINE LIMITED), and therefore, a curing agent dispersion liquid formed by dispersing a curing agent is prepared. Measurement is performed by using a laser diffraction particle diameter measurement machine. A volume average particle diameter of the curing agent in the curing agent dispersion liquid is 0.6 pm, and a solid content ratio of the curing agent dispersion liquid is 25%.

Preparation of Curing Agent Dispersion Liquid (B2)

A curing agent dispersion (B2) is prepared in the same method as in the preparation of the curing agent dispersion liquid (B1) except that VESTAGONB1540 (manufactured by Evonik Japan Co., Ltd.) is used instead of blocked isocyanate curing agent VESTAGONB1530 (manufactured by Evonik Japan Co., Ltd.). Measurement is performed by using a laser diffraction particle diameter measurement machine. A volume average particle diameter of the curing agent in the curing agent dispersion liquid (B2) is 0.6 um, and a solid content ratio of the curing agent dispersion liquid is 25%.

Preparation of Acrylic Resin and Curing Agent Composite Dispersion Liquid (C1)

A mixed solvent of 180 parts by mass of ethyl acetate and 80 parts by mass of isopropyl alcohol is put into a reaction vessel (BJ-30N, manufactured by TOKYO RIKAKIKAI CO, LTD.) provided with a jacket which includes a condenser, a thermometer, a water dropping device, and an anchor blade while maintaining the reaction vessel at 40° C. in a water circulation type thermostatic bath, and the following compositions are put into the reaction vessel.

208 parts by mass of Acrylic resin (1) (a polymer of styrene/n-butyl acrylate/2-hydroxypropyl methacrylate/acrylic acid (molar ratio=100/18/25/4 (mol %), weight-average molecular weight (Mw)=42,000, number average molecular weight (Mn)=15, 000)); 92 parts by mass of blocked isocyanate curing agent VESTAGONB1530 (manufactured by Evonik Japan Co., Ltd.); and 3 parts by mass of acrylic oligomer (ACRONAL 4F, BASF SE) are put into the reaction vessel. Thereafter, the mixture is stirred at 150 rpm by using a three-one motor and dissolved to obtain an oil phase. A mixed solution of 1 part by mass of a 10% by weight ammonia aqueous solution and 47 parts by mass of an aqueous solution of 5% by weight sodium hydroxide is added dropwise over 5 minutes into the oil phase being stirred, and is mixed for 10 minutes, and thereafter, 900 parts by mass of ion exchange water is further added dropwise thereinto at a rate of 5 parts by mass per a minute to allow a phase inversion, and therefore an emulsified liquid is obtained.

Immediately, 800 parts by mass of the obtained emulsified liquid and 700 parts by mass of ion exchange water are put into an eggplant flask, are set in an evaporator provided with a vacuum control unit (manufactured by TOKYO RIKAKIKAI CO, LTD.) through a trap bulb. The eggplant flask is heated in a hot water bath at 60° C. while rotating the flask, and a solvent is removed by reducing a pressure to 7 kPa while being careful of bumping. When a recovery amount of the solvent becomes 1,100 parts by mass, the pressure returns to the normal pressure, and the eggplant flask is cooled to obtain a dispersion liquid. There is no solvent odor in the obtained dispersion liquid. A volume average particle diameter of resin particles in the dispersion liquid is 145 nm.

Thereafter, 2% by weight of an anionic surfactant (Dowfax2A1 manufactured by The Dow Chemical Company, an amount of effective component: 45% by weight) is added and mixed as an effective component with respect to a resin content in the dispersion liquid, and adjustment is performed such that a concentration of solid contents becomes 25% by weight by adding ion exchange water thereto. This is used as the acrylic resin and curing agent composite dispersion (C1).

Preparation of Polyester Resin and Curing Agent Composite Dispersion Liquid (E1)

A mixed solvent of 180 parts by mass of ethyl acetate and 80 parts by mass of isopropyl alcohol is put into a reaction vessel (BJ-30N, manufactured by TOKYO RIKAKIKAI CO, LTD.) provided with a jacket which includes a condenser, a thermometer, a water dropping device, and an anchor blade while maintaining the reaction vessel at 40° C. in a water circulation type thermostatic bath, and the following compositions are put into the reaction vessel.

Polyester resin (PES1) (a polycondensate of terephthalic acid/ethylene glycol/neopentyl glycol/trimethylol propane (molar ratio=100/60/38/2 (mol %) , glass transition temperature=62° C., acid value (Av)=12 mgKOH/g, hydroxyl value (OHv)=55 mgKOH/g, weight-average molecular weight (Mw)=12,000, and number average molecular weight (Mn)=4,000): 240 parts by mass

Blocked isocyanate curing agent VESTAGONB1530 (manufactured by Evonik Japan Co., Ltd.): 60 parts by mass

Benzoin: 1.5 parts by mass

Acrylic oligomer (ACRONAL 4F manufactured by BASF SE): 3 parts by mass

After putting into the reaction vessel, the mixture is stirred at 150 rpm using a three-one motor to perform dissolution, and therefore an oil phase is obtained. A mixed solution of 1 part by mass of a 10% by weight ammonia aqueous solution and 47 parts by mass of an aqueous solution of 5% by weight sodium hydroxide is added dropwise over 5 minutes into the oil phase being stirred, and is mixed for 10 minutes, and thereafter, 900 parts by mass of ion exchange water is further added dropwise thereinto at a rate of 5 parts by mass per a minute to allow a phase inversion, and therefore an emulsified liquid is obtained.

Immediately, 800 parts by mass of the obtained emulsified liquid and 700 parts by mass of ion exchange water are put into an eggplant flask, are set in an evaporator provided with a vacuum control unit (manufactured by TOKYO RIKAKIKAI CO, LTD.) through a trap bulb. The eggplant flask is heated in a hot water bath at 60° C. while rotating the flask, and a solvent is removed by reducing a pressure to 7 kPa while being careful of bumping. When a recovery amount of the solvent becomes 1,100 parts by mass, the pressure returns to the normal pressure, and the eggplant flask is cooled to obtain a dispersion liquid. There is no solvent odor in the obtained dispersion liquid. A volume average particle diameter of resin particles in the dispersion liquid is 145 nm.

Thereafter, 2% by weight of an anionic surfactant (Dowfax2A1 manufactured by The Dow Chemical Company, an amount of effective component: 45% by weight) is added and mixed as an effective component with respect to a resin content in the dispersion liquid, and adjustment is performed such that a concentration of solid contents becomes 25% by weight by adding ion exchange water thereto. This is used as the polyester resin and curing agent composite dispersion liquid (E1).

Preparation of Crosslinked Resin Particle Dispersion Liquid (F1)

Styrene: 10 parts by mass

Butyl acrylate: 65 parts by mass

2-Hydroxypropyl methacrylate: 13 parts by mass

1,10-Decanediol diacrylate: 9.4 parts by mass

The above components are mixed and dissolved to prepare a solution. Meanwhile, 18 parts by mass of an anionic surfactant (DOWFAX, manufactured by The Dow Chemical Company) is dissolved in 300 parts by mass of ion exchange water, the above solution is added thereto, and the mixture is dispersed in a flask and emulsified to prepare a solution (monomer emulsified liquid F).

In addition, 1 part by mass of an anionic surfactant (DOWFAX, manufactured by The Dow Chemical Company) is dissolved in 300 parts by mass of ion exchange water, and charged into a polymerization flask.

The polymerization flask is tightly sealed, a recirculating pipe is installed, and the polymerization flask is heated to 75° C. with a water bath and maintained while introducing nitrogen and while slowly stirring. 9 parts by mass of ammonium persulfate is dissolved in 37 parts by mass of ion exchange water and added dropwise into the polymerization flask through a metering pump over 20 minutes, and thereafter, the monomer emulsified liquid F is also added dropwise thereinto through a metering pump over 120 minutes. Thereafter, the polymerization flask is maintained at 75° C. for 3 hours while stirring is continued slowly to complete the polymerization.

Accordingly, a crosslinked resin particle dispersion liquid (F1) in which a particle diameter is 95 nm, and a solid content is 10% is obtained.

Preparation of Crosslinked Resin Particle Dispersion Liquid (F2)

Styrene: 10 parts by mass

Butyl acrylate: 65 parts by mass

2-Hydroxypropyl methacrylate: 13 parts by mass

Divinylbenzene: 9.0 parts by mass

The above components are mixed and dissolved to prepare a solution. Meanwhile, 18 parts by mass of an anionic surfactant (DOWFAX, manufactured by The Dow Chemical Company) is dissolved in 300 parts by mass of ion exchange water, the above solution is added thereto, and the mixture is dispersed in a flask and emulsified to prepare a solution (monomer emulsified liquid F).

In addition, 1 part by mass of an anionic surfactant (DOWFAX, manufactured by The Dow Chemical Company) is dissolved in 300 parts by mass of ion exchange water, and charged into a polymerization flask.

The polymerization flask is tightly sealed, a recirculating pipe is installed, and the polymerization flask is heated to 75° C. with a water bath and maintained while introducing nitrogen and while slowly stirring. 9 parts by mass of ammonium persulfate is dissolved in 37 parts by mass of ion exchange water and added dropwise into the polymerization flask through a metering pump over 20 minutes, and thereafter, the monomer emulsified liquid F is also added dropwise thereinto through a metering pump over 120 minutes. Thereafter, the polymerization flask is maintained at 75° C. for 3 hours while stirring is continued slowly to complete the polymerization.

Accordingly, a crosslinked resin particle dispersion liquid (F2) in which a particle diameter is 95 nm, and a solid content is 10% is obtained.

Preparation of White Powder Particles (1)

Aggregation Step

Acrylic resin dispersion liquid (A1) : 180 parts by mass (solid content: 45 parts by mass)

Curing agent dispersion liquid (B1): 107 parts by mass (solids content: 25 parts by mass)

White pigment dispersion liquid (W1) : 161 parts by mass (solid content: 40 parts by mass)

Ion exchange water: 335 parts by mass

The components described above are mixed and dispersed in a round stainless steel flask by using a homogenizer (ULTRA-TURRAX T50, manufactured by IKA Works GmbH & Co.) . 0.75 parts of an aqueous solution of 10% by weight of polyaluminum chloride is added thereto, and a dispersing operation is continuously performed by using ULTRA-TURRAX.

A stirrer and a mantle heater are installed, a temperature is raised up to 50° C. while adjusting a rotation speed of the stirrer such that slurry is sufficiently stirred, the slurry is maintained at 50° C. for 15 minutes, and then a particle diameter of aggregated particles is measured by using TA-II type COULTER COUNTER (manufactured by Beckman Coulter, Inc., aperture diameter: 50 μm). When a volume average particle diameter becomes 6.5 μm, a mixed solution of 20 parts by mass of the acrylic resin dispersion liquid (A1), 12 parts by mass of the curing agent dispersion liquid (B1), and 75 parts by mass of ion exchange water is slowly put as a shell.

Coalescence Union Step

After maintaining for 30 minutes after the addition, a pH of the system is adjusted to 6.5 with a 0.5 mol/liter aqueous solution of sodium hydroxide. Thereafter, heating is performed to 95° C. while continuing stirring, and the temperature is maintained for 2 hours.

Filtering, Washing, and Drying Step

After the reaction ends, a solution in the flask is cooled and is filtered, and therefore a solid content is obtained. Next, this solid content is washed with ion exchange water, and then, solid liquid separation is performed by Nutsche type suction filtration, and therefore a solid content is obtained again.

Next, this solid content is dispersed again in 3,000 parts by mass of ion exchange water at 40° C., and stirred at 300 rpm for 15 minutes, and washed. The washing operation is repeated 5 times, the solid content obtained by performing the solid liquid separation by the Nutsche type suction filtration is subjected to vacuum drying for 12 hours, and therefore white powder particles (1) are obtained.

When a particle diameter of the white powder particles is measured, a volume average particle diameter D₅₀ᵥ is 7.1 um, and a volume average particle size distribution index GSDv is 1.25. An average circularity is 0.98.

Preparation of Clear Powder Particles (2)

Clear powder particles (2) are produced by using only the acrylic resin dispersion liquid and the curing agent dispersion liquid, in the same step as above.

When a particle diameter of the clear powder particles is measured, a volume average particle diameter D₅₀ᵥ is 7.2 μm, and a volume average particle size distribution index GSDv is 1.26. An average circularity is 0.97.

Preparation of White Powder Particles (3)

Aggregation Step

Acrylic resin and curing agent composite dispersion (M1): 268 parts by mass (solid content: 38 parts by mass)

White pigment dispersion liquid (W1): 161 parts by mass (solid content: 40 parts by mass)

Ion exchange water: 340 parts by mass

The components described above are mixed and dispersed in a round stainless steel flask by using a homogenizer (ULTRA-TURRAX T50, manufactured by IKA Works GmbH & Co.) . Next, a pH is adjusted to 3.5 by using an aqueous solution of 1.0% by weight of nitric acid. 0.75 parts of an aqueous solution of 10% by weight of polyaluminum chloride is added thereto, and a dispersing operation is continuously performed by using ULTRA-TURRAX.

A stirrer and a mantle heater are installed, a temperature is raised up to 50° C. while adjusting a rotation speed of the stirrer such that slurry is sufficiently stirred, the slurry is maintained at 50° C. for 15 minutes, and then a particle diameter of aggregated particles is measured by using TA-II type COULTER COUNTER (manufactured by Beckman Coulter, Inc., aperture diameter: 50 μm). When a volume average particle diameter becomes 6.5 μm, a mixed solution of 48 parts by mass of the acrylic resin and curing agent composite dispersion (M1) and 75 parts by mass of ion exchange water is slowly put as a shell.

Coalescence Union Step

After maintaining for 30 minutes after the addition, a pH of the system is adjusted to 7.0 with a 0.5 mol/liter aqueous solution of sodium hydroxide. Thereafter, heating is performed to 95° C. while continuing stirring, and the temperature is maintained for 2 hours.

Filtering, Washing, and Drying Step

After the reaction ends, a solution in the flask is cooled and is filtered, and therefore a solid content is obtained. Next, this solid content is washed with ion exchange water, and then, solid liquid separation is performed by Nutsche type suction filtration, and therefore a solid content is obtained again.

Next, this solid content is dispersed again in 3,000 parts by mass of ion exchange water at 40° C., and stirred at 300 rpm for 15 minutes, and washed. The washing operation is repeated 5 times, the solid content obtained by performing the solid liquid separation by the Nutsche type suction filtration is subjected to vacuum drying for 12 hours, and therefore white powder particles (3) are obtained.

When a particle diameter of the white powder particles is measured, a volume average particle diameter D₅₀ᵥ is 7.5 μm, and a volume average particle size distribution index GSDv is 1.27. An average circularity is 0.97.

Preparation of Clear Powder Particles (4)

Clear powder particles (4) are produced by using only the acrylic resin dispersion liquid and the curing agent dispersion liquid, in the same step as above.

When a particle diameter of the clear powder particles is measured, a volume average particle diameter D₅₀ᵥis 7.4 μm, and a volume average particle size distribution index GSDv is 1.25. An average circularity is 0.98.

Preparation of White Powder Particles (5)

White powder particles (5) having a volume particle diameter D₅₀ᵥ of 15 μm is obtained in the same step as the preparation of the white powder particles (3) except that the coalescence union step is adjusted.

Preparation of White Powder Particles (6)

White powder particles (6) having a volume particle diameter D₅₀ᵥ of 25 μm is obtained in the same step as the preparation of the white powder particles (3) except that the coalescence union step is adjusted.

Preparation of White Powder Particles (7)

Aggregation Step

Acrylic resin dispersion liquid (A2): 167 parts by mass (solid content: 45 parts by mass)

Curing agent dispersion liquid (B2): 132 parts by mass (solids content: 25 parts by mass)

White pigment dispersion liquid (W1): 161 parts by mass (solid content: 40 parts by mass)

Ion exchange water: 320 parts by mass

The components described above are mixed and dispersed in a round stainless steel flask by using a homogenizer (ULTRA-TURRAX T50, manufactured by IKA Works GmbH & Co.) . 0.75 parts of an aqueous solution of 10% by weight of polyaluminum chloride is added thereto, and a dispersing operation is continuously performed by using ULTRA-TURRAX.

A stirrer and a mantle heater are installed, a temperature is raised up to 50° C. while adjusting a rotation speed of the stirrer such that slurry is sufficiently stirred, the slurry is maintained at 50° C. for 15 minutes, and then a particle diameter of aggregated particles is measured by using TA-II type COULTER COUNTER (manufactured by Beckman Coulter, Inc., aperture diameter: 50 μm). When a volume average particle diameter becomes 6.5 μm, a mixed solution of 19 parts by mass of the acrylic resin dispersion liquid (A1), 15 parts by mass of the curing agent dispersion liquid (B1), and 75 parts by mass of ion exchange water is slowly put as a shell.

Coalescence Union Step

After maintaining for 30 minutes after the addition, a pH of the system is adjusted to 6.5 with a 0.5 mol/liter aqueous solution of sodium hydroxide. Thereafter, heating is performed to 95° C. while continuing stirring, and the temperature is maintained for 2 hours.

Filtering, Washing, and Drying Step

After the reaction ends, a solution in the flask is cooled and is filtered, and therefore a solid content is obtained. Next, this solid content is washed with ion exchange water, and then, solid liquid separation is performed by Nutsche type suction filtration, and therefore a solid content is obtained again.

Next, this solid content is dispersed again in 3,000 parts by mass of ion exchange water at 40° C., and stirred at 300 rpm for 15 minutes, and washed. The washing operation is repeated 5 times, the solid content obtained by performing the solid liquid separation by the Nutsche type suction filtration is subjected to vacuum drying for 12 hours, and therefore white powder particles (7) are obtained.

When a particle diameter of the white powder particles is measured, a volume average particle diameter D₅₀ᵥ is 8.3 μm, and a volume average particle size distribution index GSDv is 1.22. An average circularity is 0.98.

Preparation of Clear Powder Particles (8)

Clear powder particles (8) are produced by using only the acrylic resin dispersion liquid and the curing agent dispersion liquid, in the same step as above.

When a particle diameter of the clear powder particles is measured, a volume average particle diameter D₅₀ᵥ is 8.5 μm, and a volume average particle size distribution index GSDv is 1.25. An average circularity is 0.97.

Preparation of White Powder Particles (9)

Aggregation Step

Acrylic resin dispersion liquid (A3): 121 parts by mass (solid content: 45 parts by mass)

Curing agent dispersion liquid (B1): 132 parts by mass (solids content: 25 parts by mass)

White pigment dispersion liquid (W1): 161 parts by mass (solid content: 40 parts by mass)

Ion exchange water: 280 parts by mass

The components described above are mixed and dispersed in a round stainless steel flask by using a homogenizer (ULTRA-TURRAX T50, manufactured by IKA Works GmbH & Co.). 0.75 parts of an aqueous solution of 10% by weight of polyaluminum chloride is added thereto, and a dispersing operation is continuously performed by using ULTRA-TURRAX.

A stirrer and a mantle heater are installed, a temperature is raised up to 50° C. while adjusting a rotation speed of the stirrer such that slurry is sufficiently stirred, the slurry is maintained at 50° C. for 15 minutes, and then a particle diameter of aggregated particles is measured by using TA-II type COULTER COUNTER (manufactured by Beckman Coulter, Inc., aperture diameter: 50 μm). When a volume average particle diameter becomes 6.5 μm, a mixed solution of 13 parts by mass of the acrylic resin dispersion liquid (A3), 24 parts by mass of the curing agent dispersion liquid (B1), and 75 parts by mass of ion exchange water is slowly put as a shell.

Coalescence Union Step

After maintaining for 30 minutes after the addition, a pH of the system is adjusted to 6.5 with a 0.5 mol/liter aqueous solution of sodium hydroxide. Thereafter, heating is performed to 95° C. while continuing stirring, and the temperature is maintained for 2 hours.

Filtering, Washing, and Drying Step

After the reaction ends, a solution in the flask is cooled and is filtered, and therefore a solid content is obtained. Next, this solid content is washed with ion exchange water, and then, solid liquid separation is performed by Nutsche type suction filtration, and therefore a solid content is obtained again.

Next, this solid content is dispersed again in 3,000 parts by mass of ion exchange water at 40° C., and stirred at 300 rpm for 15 minutes, and washed. The washing operation is repeated 5 times, the solid content obtained by performing the solid liquid separation by the Nutsche type suction filtration is subjected to vacuum drying for 12 hours, and therefore white powder particles (9) are obtained.

When a particle diameter of the white powder particles is measured, a volume average particle diameter D₅₀ᵥ is 7.3 μm, and a volume average particle size distribution index GSDv is 1.24. An average circularity is 0.98.

Preparation of Clear Powder Particles (10)

Clear powder particles (10) are produced by using only the acrylic resin dispersion liquid and the curing agent dispersion liquid, in the same step as above.

When a particle diameter of the clear powder particles is measured, a volume average particle diameter D₅₀ᵥ is 8.9 μm, and a volume average particle size distribution index GSDv is 1.25. An average circularity is 0.96.

Preparation of White Powder Particles (11)

Aggregation Step

Acrylic resin dispersion liquid (A4): 144 parts by mass (solid content: 45 parts by mass)

Curing agent dispersion liquid (B2): 171 parts by mass (solids content: 25 parts by mass)

White pigment dispersion liquid (W1): 161 parts by mass (solid content: 40 parts by mass)

Crosslinked resin particle dispersion liquid (F1): 85 parts by mass (solid content: 10 parts by mass)

Ion exchange water: 200 parts by mass

The components described above are mixed and dispersed in a round stainless steel flask by using a homogenizer (ULTRA-TURRAX T50, manufactured by IKA Works GmbH & Co.). 0.77 parts of an aqueous solution of 10% by weight of polyaluminum chloride is added thereto, and a dispersing operation is continuously performed by using ULTRA-TURRAX.

A stirrer and a mantle heater are installed, a temperature is raised up to 50° C. while adjusting a rotation speed of the stirrer such that slurry is sufficiently stirred, the slurry is maintained at 50° C. for 15 minutes, and then a particle diameter of aggregated particles is measured by using TA-II type COULTER COUNTER (manufactured by Beckman Coulter, Inc., aperture diameter: 50 μm). When a volume average particle diameter becomes 9.5 μm, a mixed solution of 16 parts by mass of the acrylic resin dispersion liquid (A4), 19 parts by mass of the curing agent dispersion liquid (B1), and 75 parts by mass of ion exchange water is slowly put as a shell.

Coalescence Union Step

After maintaining for 30 minutes after the addition, a pH of the system is adjusted to 6.5 with a 0.5 mol/liter aqueous solution of sodium hydroxide. Thereafter, heating is performed to 95° C. while continuing stirring, and the temperature is maintained for 2 hours.

Filtering, Washing, and Drying Step

After the reaction ends, a solution in the flask is cooled and is filtered, and therefore a solid content is obtained. Next, this solid content is washed with ion exchange water, and then, solid liquid separation is performed by Nutsche type suction filtration, and therefore a solid content is obtained again.

Next, this solid content is dispersed again in 3,000 parts by mass of ion exchange water at 40° C., and stirred at 300 rpm for 15 minutes, and washed. The washing operation is repeated 5 times, the solid content obtained by performing the solid liquid separation by the Nutsche type suction filtration is subjected to vacuum drying for 12 hours, and therefore white powder particles (11) are obtained.

When a particle diameter of the white powder particles is measured, a volume average particle diameter D₅₀ᵥ is 10.8 μm, and a volume average particle size distribution index GSDv is 1.24. An average circularity is 0.98.

Preparation of Clear Powder Particles (12)

Clear powder particles (12) are produced by using only the acrylic resin dispersion liquid, the curing agent dispersion liquid, and 170 parts of the crosslinked resin particle dispersion liquid, in the same step as above.

When a particle diameter of the clear powder particles is measured, a volume average particle diameter D₅₀ᵥ is 11.1 μm, and a volume average particle size distribution index GSDv is 1.25. An average circularity is 0.96.

Preparation of White Powder Particles (13)

Aggregation Step

Acrylic resin dispersion liquid (A5) : 154 parts by mass (solid content: 45 parts by mass)

Curing agent dispersion liquid (B1): 152 parts by mass (solids content: 25 parts by mass)

White pigment dispersion liquid (W1) : 161 parts by mass (solid content: 40 parts by mass)

Crosslinked resin particle dispersion liquid (F1): 95 parts by mass (solid content: 10 parts by mass)

Ion exchange water: 190 parts by mass

The components described above are mixed and dispersed in a round stainless steel flask by using a homogenizer (ULTRA-TURRAX T50, manufactured by IKA Works GmbH & Co.) . 0.77 parts of an aqueous solution of 10% by weight of polyaluminum chloride is added thereto, and a dispersing operation is continuously performed by using ULTRA-TURRAX.

A stirrer and a mantle heater are installed, a temperature is raised up to 50° C. while adjusting a rotation speed of the stirrer such that slurry is sufficiently stirred, the slurry is maintained at 50° C. for 15 minutes, and then a particle diameter of aggregated particles is measured by using TA-II type COULTER COUNTER (manufactured by Beckman Coulter, Inc., aperture diameter: 50 μm). When a volume average particle diameter becomes 9.5 μm, a mixed solution of 17 parts by mass of the acrylic resin dispersion liquid (A5), 17 parts by mass of the curing agent dispersion liquid (B1), and 75 parts by mass of ion exchange water is slowly put as a shell.

Coalescence Union Step

After maintaining for 30 minutes after the addition, a pH of the system is adjusted to 6.5 with a 0.5 mol/liter aqueous solution of sodium hydroxide. Thereafter, heating is performed to 95° C. while continuing stirring, and the temperature is maintained for 2 hours.

Filtering, Washing, and Drying Step

After the reaction ends, a solution in the flask is cooled and is filtered, and therefore a solid content is obtained. Next, this solid content is washed with ion exchange water, and then, solid liquid separation is performed by Nutsche type suction filtration, and therefore a solid content is obtained again.

Next, this solid content is dispersed again in 3,000 parts by mass of ion exchange water at 40° C., and stirred at 300 rpm for 15 minutes, and washed. The washing operation is repeated 5 times, the solid content obtained by performing the solid liquid separation by the Nutsche type suction filtration is subjected to vacuum drying for 12 hours, and therefore white powder particles (13) are obtained.

When a particle diameter of the white powder particles is measured, a volume average particle diameter D₅₀ᵥ is 10.6 pm, and a volume average particle size distribution index GSDv is 1.25. An average circularity is 0.96.

Preparation of Clear Powder Particles (14)

Clear powder particles (14) are produced by using only the acrylic resin dispersion liquid, the curing agent dispersion liquid, and 190 parts of the crosslinked resin particle dispersion liquid, in the same step as above.

When a particle diameter of the clear powder particles is measured, a volume average particle diameter D₅₀ᵥ is 10.05 pm, and a volume average particle size distribution index GSDv is 1.23. An average circularity is 0.95.

Preparation of White Powder Particles (15)

Aggregation Step

Acrylic resin dispersion liquid (A6) : 144 parts by mass (solid content: 45 parts by mass)

Curing agent dispersion liquid (B2): 171 parts by mass (solids content: 25 parts by mass)

White pigment dispersion liquid (W1): 161 parts by mass (solid content: 40 parts by mass)

Crosslinked resin particle dispersion liquid (F2): 75 parts by mass (solid content: 10 parts by mass)

Ion exchange water: 210 parts by mass

The components described above are mixed and dispersed in a round stainless steel flask by using a homogenizer (ULTRA-TURRAX T50, manufactured by IKA Works GmbH & Co.) . 0.77 parts of an aqueous solution of 10% by weight of polyaluminum chloride is added thereto, and a dispersing operation is continuously performed by using ULTRA-TURRAX.

A stirrer and a mantle heater are installed, a temperature is raised up to 50° C. while adjusting a rotation speed of the stirrer such that slurry is sufficiently stirred, the slurry is maintained at 50° C. for 15 minutes, and then a particle diameter of aggregated particles is measured by using TA-II type COULTER COUNTER (manufactured by Beckman Coulter, Inc., aperture diameter: 50 μm). When a volume average particle diameter becomes 9.5 μm, a mixed solution of 16 parts by mass of the acrylic resin dispersion liquid (A6), 19 parts by mass of the curing agent dispersion liquid (B1), and 75 parts by mass of ion exchange water is slowly put as a shell.

Coalescence Union Step

After maintaining for 30 minutes after the addition, a pH of the system is adjusted to 6.5 with a 0.5 mol/liter aqueous solution of sodium hydroxide. Thereafter, heating is performed to 95° C. while continuing stirring, and the temperature is maintained for 2 hours.

Filtering, Washing, and Drying Step

After the reaction ends, a solution in the flask is cooled and is filtered, and therefore a solid content is obtained. Next, this solid content is washed with ion exchange water, and then, solid liquid separation is performed by Nutsche type suction filtration, and therefore a solid content is obtained again.

Next, this solid content is dispersed again in 3,000 parts by mass of ion exchange water at 40° C., and stirred at 300 rpm for 15 minutes, and washed. The washing operation is repeated 5 times, the solid content obtained by performing the solid liquid separation by the Nutsche type suction filtration is subjected to vacuum drying for 12 hours, and therefore white powder particles (15) are obtained.

When a particle diameter of the white powder particles is measured, a volume average particle diameter D₅₀ᵥ is 10.1 μm, and a volume average particle size distribution index GSDv is 1.25. An average circularity is 0.97.

Preparation of Clear Powder Particles (16)

Clear powder particles (16) are produced by using only the acrylic resin dispersion liquid, the curing agent dispersion liquid, and 150 parts of the crosslinked resin particle dispersion liquid, in the same step as above.

When a particle diameter of the clear powder particles is measured, a volume average particle diameter D₅₀ᵥ is 11.0 μm, and a volume average particle size distribution index GSDv is 1.27. An average circularity is 0.92.

Preparation of White Powder Particles (17)

Aggregation Step

Acrylic resin dispersion liquid (A7) : 154 parts by mass (solid content: 45 parts by mass)

Curing agent dispersion liquid (B1): 152 parts by mass (solids content: 25 parts by mass)

White pigment dispersion liquid (W1): 161 parts by mass (solid content: 40 parts by mass)

Ion exchange water: 280 parts by mass

The components described above are mixed and dispersed in a round stainless steel flask by using a homogenizer (ULTRA-TURRAX T50, manufactured by IKA Works GmbH & Co.) . 0.77 parts of an aqueous solution of 10% by weight of polyaluminum chloride is added thereto, and a dispersing operation is continuously performed by using ULTRA-TURRAX.

A stirrer and a mantle heater are installed, a temperature is raised up to 50° C. while adjusting a rotation speed of the stirrer such that slurry is sufficiently stirred, the slurry is maintained at 50° C. for 15 minutes, and then a particle diameter of aggregated particles is measured by using TA-II type COULTER COUNTER (manufactured by Beckman Coulter, Inc., aperture diameter: 50 μm) . When a volume average particle diameter becomes 9.0 μm, a mixed solution of 17 parts by mass of the acrylic resin dispersion liquid (A7), 17 parts by mass of the curing agent dispersion liquid (B1), and 75 parts by mass of ion exchange water is slowly put as a shell.

Coalescence Union Step

After maintaining for 30 minutes after the addition, a pH of the system is adjusted to 6.5 with a 0.5 mol/liter aqueous solution of sodium hydroxide. Thereafter, heating is performed to 95° C. while continuing stirring, and the temperature is maintained for 2 hours.

Filtering, Washing, and Drying Step

After the reaction ends, a solution in the flask is cooled and is filtered, and therefore a solid content is obtained. Next, this solid content is washed with ion exchange water, and then, solid liquid separation is performed by Nutsche type suction filtration, and therefore a solid content is obtained again.

Next, this solid content is dispersed again in 3,000 parts by mass of ion exchange water at 40° C., and stirred at 300 rpm for 15 minutes, and washed. The washing operation is repeated 5 times, the solid content obtained by performing the solid liquid separation by the Nutsche type suction filtration is subjected to vacuum drying for 12 hours, and therefore white powder particles (17) are obtained.

When a particle diameter of the white powder particles is measured, a volume average particle diameter D₅₀ᵥis 9.8 μm, and a volume average particle size distribution index GSDv is 1.23. An average circularity is 0.93.

Preparation of Clear Powder Particles (18)

Clear powder particles (18) are produced by using only the acrylic resin dispersion liquid and the curing agent dispersion liquid, in the same step as above.

When a particle diameter of the clear powder particles is measured, a volume average particle diameter D₅₀ᵥ is 10.2 pm, and a volume average particle size distribution index GSDv is 1.24. An average circularity is 0.92.

Preparation of White Powder Particles (19)

Aggregation Step

Polyester resin and curing agent composite dispersion liquid (E1): 180 parts by mass (solid content: 45 parts by mass)

White pigment dispersion liquid (W1): 160 parts by mass (solid content: 40 parts by mass)

Ion exchange water: 200 parts by mass

The components described above are mixed and dispersed in a round stainless steel flask by using a homogenizer (ULTRA-TURRAX T50, manufactured by IKA Works GmbH & Co.) . Next, a pH is adjusted to 3.5 by using an aqueous solution of 1.0% by weight of nitric acid. 0.50 parts of an aqueous solution of 10% by weight of polyaluminum chloride is added thereto, and a dispersing operation is continuously performed by using ULTRA-TURRAX.

A stirrer and a mantle heater are installed, a temperature is raised up to 50° C. while adjusting a rotation speed of the stirrer such that slurry is sufficiently stirred, the slurry is maintained at 50° C. for 15 minutes, and then a particle diameter of aggregated particles is measured by using TA-II type COULTER COUNTER (manufactured by Beckman Coulter, Inc., aperture diameter: 50 μm). When a volume average particle diameter becomes 7.5 μm, 60 parts by mass of the polyester resin and curing agent composite dispersion liquid (E1) is slowly put as a shell (the shell is put into the flask).

Coalescence Union Step

After maintaining for 30 minutes after the addition, a pH is adjusted to 7.0 by using an aqueous solution of 5% of sodium hydroxide. Thereafter, a temperature is raised up to 85° C. and maintained for 2 hours.

Filtering, Washing, and Drying Step

After the reaction ends, a solution in the flask is cooled and is filtered, and therefore a solid content is obtained. Next, this solid content is washed with ion exchange water, and then, solid liquid separation is performed by Nutsche type suction filtration, and therefore a solid content is obtained again.

Next, this solid content is dispersed again in 3,000 parts by mass of ion exchange water at 40° C., and stirred at 300 rpm for 15 minutes, and washed. The washing operation is repeated 5 times, the solid content obtained by performing the solid liquid separation by the Nutsche type suction filtration is subjected to vacuum drying for 12 hours, and therefore white powder particles (19) are obtained.

When a particle diameter of the white powder particles is measured, a volume average particle diameter D₅₀ᵥ is 8.1 μm, and a volume average particle size distribution index GSDv is 1.28. An average circularity is 0.98.

Preparation of Kneaded and Pulverized White Powder Particles (20)

Titanium oxide (A-220 manufactured by ISHIHARA SANGYO KAISHA, LTD.): 200 parts by mass

Polyester resin (PES1) (a polycondensate of terephthalic acid/ethylene glycol/neopentyl glycol/trimethylol propane (molar ratio=100/60/38/2 (mol %), glass transition temperature=62° C., acid value (Av)=12 mgKOH/g, hydroxyl value (OHv)=55 mgKOH/g, weight-average molecular weight (Mw)=12,000, and number average molecular weight (Mn)=4,000): 240 parts by mass

Blocked isocyanate curing agent VESTAGONB1530 (manufactured by Evonik Japan Co., Ltd.): 60 parts by mass

Benzoin: 1.5 parts by mass

Acrylic oligomer (ACRONAL 4F manufactured by BASF SE): 3 parts by mass

The above components are preliminarily mixed in a mixer, and then kneaded by an extruder while being heated to 100° C., followed by coarse pulverization to obtain flakes. Next, fine pulverization is carried out using a turbo mill aiming at a particle diameter of 10 μm, and classification is carried out to obtain a kneaded and pulverized white powder coating material (20).

When a particle diameter of the white powder particles is measured, a volume average particle diameter D₅₀ᵥ is 9.81 pm, and a volume average particle size distribution index GSDv is 1.32.

Preparation of Kneaded and Pulverized White Powder Particles (21)

Titanium oxide (A-220 manufactured by ISHIHARA SANGYO KAISHA, LTD.): 186 parts by mass

Acrylic resin (2) (a polymer of styrene/n-butyl acrylate/2-hydroxyethyl methacrylate/acrylic acid (molar ratio=100/20/24/1 (mol%), weight-average molecular weight (Mw)=18,000, number average molecular weight (Mn)=6,000)): 240 parts by mass

Blocked isocyanate curing agent VESTAGONB1358 (manufactured by Evonik Japan Co., Ltd.): 105 parts by mass

Acrylic particles: 5 parts by mass

Benzoin: 1.5 parts by mass

Acrylic oligomer (ACRONAL 4F manufactured by BASF SE): 3 parts by mass

The above components are preliminarily mixed in a mixer, and then kneaded by an extruder while being heated to 100° C., followed by coarse pulverization to obtain flakes. Next, fine pulverization is carried out using a turbo mill aiming at a particle diameter of 30 μm, and classification is carried out to obtain a kneaded and pulverized white powder coating material (21).

When a particle diameter of the white powder particles is measured, a volume average particle diameter D₅₀ᵥ is 30.2 μm.

Preparation of Kneaded and Pulverized White Powder Particles (22)

Titanium oxide (A-220 manufactured by ISHIHARA SANGYO KAISHA, LTD.): 173 parts by mass

Acrylic resin (2) (a polymer of styrene/n-butyl acrylate/glycidyl methacrylate/acrylic acid (molar ratio=100/20/60/1 (mol %), weight-average molecular weight (Mw)=22,000, number average molecular weight (Mn)=8,000)): 240 parts by mass

Dodecanedioic acid: 83 parts by mass

Acrylic particles: 5 parts by mass

Benzoin: 1.5 parts by mass

Acrylic oligomer (ACRONAL 4F manufactured by BASF SE): 3 parts by mass

The above components are preliminarily mixed in a mixer, and then kneaded by an extruder while being heated to 100° C., followed by coarse pulverization to obtain flakes. Next, fine pulverization is carried out using a turbo mill aiming at a particle diameter of 30 μm, and classification is carried out to obtain a kneaded and pulverized white powder coating material (22).

When a particle diameter of the white powder particles is measured, a volume average particle diameter D₅₀ᵥ is 31.1 μm.

Preparation of Clear Powder Particles (23)

Aggregation Step

Acrylic resin dispersion liquid (A4) : 144 parts by mass (solid content: 45 parts by mass)

Curing agent dispersion liquid (B2): 171 parts by mass (solids content: 25 parts by mass)

Inorganic particle dispersion liquid (silica particles, average particle diameter: 45 nm, SNOWTEX ST-OL manufactured by Nissan Chemical Corporation): 43 parts by mass (solid content: 20 parts by mass)

Ion exchange water: 800 parts by mass

The components described above are mixed and dispersed in a round stainless steel flask by using a homogenizer (ULTRA-TURRAX T50, manufactured by IKA Works GmbH & Co.) . 0.80 parts of an aqueous solution of 10% by weight of polyaluminum chloride is added thereto, and a dispersing operation is continuously performed by using ULTRA-TURRAX.

A stirrer and a mantle heater are installed, a temperature is raised up to 50° C. while adjusting a rotation speed of the stirrer such that slurry is sufficiently stirred, the slurry is maintained at 50° C. for 15 minutes, and then a particle diameter of aggregated particles is measured by using TA-II type COULTER COUNTER (manufactured by Beckman Coulter, Inc., aperture diameter: 50 μm). When a volume average particle diameter becomes 9.5 μm, a mixed solution of 16 parts by mass of the acrylic resin dispersion liquid (A4), 19 parts by mass of the curing agent dispersion liquid (B2), and 75 parts by mass of ion exchange water is slowly put as a shell.

Coalescence Union Step

After maintaining for 30 minutes after the addition, a pH of the system is adjusted to 6.5 with a 0.5 mol/liter aqueous solution of sodium hydroxide. Thereafter, heating is performed to 95° C. while continuing stirring, and the temperature is maintained for 2 hours.

Filtering, Washing, and Drying Step

After the reaction ends, a solution in the flask is cooled and is filtered, and therefore a solid content is obtained. Next, this solid content is washed with ion exchange water, and then, solid liquid separation is performed by Nutsche type suction filtration, and therefore a solid content is obtained again.

Next, this solid content is dispersed again in 3,000 parts by mass of ion exchange water at 40° C., and stirred at 300 rpm for 15 minutes, and washed. The washing operation is repeated 5 times, the solid content obtained by performing the solid liquid separation by the Nutsche type suction filtration is subjected to vacuum drying for 12 hours, and therefore clear powder particles (23) are obtained.

When a particle diameter of the white powder particles is measured, a volume average particle diameter D₅₀ᵥ is 10.2 μm, and a volume average particle size distribution index GSDv is 1.25. An average circularity is 0.98.

Preparation of Liquid Coating Material (1)

Titanium oxide (A-220 manufactured by ISHIHARA SANGYO KAISHA, LTD.): 200 parts by mass

50% acrylic resin solution (2) (a polymer of styrene/n-butyl acrylate/2-hydroxyethyl methacrylate/acrylic acid (molar ratio=100/60/34/2 (mol %), weight-average molecular weight (Mw)=42,000, number average molecular weight (Mn)=15,000)): 480 parts by mass

Blocked isocyanate curing agent DURANATE TPA-B80E: 129 parts by mass

Leveling agent POLYFLOW No. 75 (manufactured by Kyoeisha Chemical Co., Ltd.) : 1 part by mass

Butyl acetate: 129 parts by mass

The components described above are mixed and dispersed in a round stainless steel flask by using a homogenizer (ULTRA-TURRAX T50, manufactured by IKA Works GmbH & Co.), and therefore a liquid coating material (1) is obtained.

Preparation of Liquid Coating Material (2)

Titanium oxide (A-220 manufactured by ISHIHARA SANGYO KAISHA, LTD.): 200 parts by mass

50% acrylic resin solution (2) (a polymer of styrene/n-butyl acrylate/2-hydroxyethyl methacrylate/acrylic acid (molar ratio=100/60/34/2 (mol%), weight-average molecular weight (Mw)=42,000, number average molecular weight (Mn)=15,000)): 480 parts by mass

Blocked isocyanate curing agent DURANATE TPA-B80E: 129 parts by mass

Acrylic particles: 5 parts by mass

Leveling agent POLYFLOW No. 75: 1 part by mass

Butyl acetate: 129 parts by mass

The components described above are mixed and dispersed in a round stainless steel flask by using a homogenizer (ULTRA-TURRAX T50, manufactured by IKA Works GmbH & Co.), and therefore a liquid coating material (2) is obtained.

Preparation of Liquid Coating Material (3)

Acrylic resin dispersion liquid (A1) : 200 parts by mass (solid content: 45 parts by mass)

Blocked isocyanate curing agent DURANATE WM44-L70G (manufactured by Asahi Kasei Corporation): 112 parts by mass

White pigment dispersion liquid (W1): 272 parts by mass (solid content: 40 parts by mass)

The components described above are mixed and dispersed in a round stainless steel flask by using a homogenizer (ULTRA-TURRAX T50, manufactured by IKA Works GmbH & Co.) , and therefore a liquid coating material (3) is obtained.

Preparation of coated film Sample of Powder Coating Material

After coating a test panel of an aluminum plate having a thickness of 1.0 mm with the powder coating material obtained in each of the examples by electrostatic coating method, heating (baking) is performed at a heating temperature of 180° C. for a heating time of 20 minutes, and therefore a coated film sample having a thickness of 40 μm is obtained.

The following evaluation is performed by using the obtained coated film sample. The evaluation results are collectively shown in Table 1.

In addition, by using the obtained powder coating material or the coated film sample, a temperature showing the minimum value in a storage elastic modulus of the powder coating material, an amount of metal ions of the powder coating material, a surface glossiness of the coated surface (60° gloss), a pencil hardness of the coated surface, and a smoothness of the coated surface (Ra and Wca) are also measured. The measurement results are shown in Table 1.

Evaluation on Moistness of Coated Surface

The coated surface of the coated product of each of the examples is visually observed and judged by the following evaluation standards.

Regarding observation conditions, under fluorescent light in the room, a degree of contrast intensity within a range of 100 μm to 400 μm is observed based on a visual system spatial frequency, at a position separated from the coated surface by 30 cm to 45 cm. When the unevenness on the surface is large, the shadow is dark and the contrast is observed strongly.

A: A coated surface on which no contrast between light and dark is observed, and an almost uniform soft reflected light is observed.

B: A coated surface on which contrast between fine light and dark is slightly observed, and nonuniform glaring reflected light is slightly observed.

C: A coated surface on which a large amount of contrast between fine light and dark is observed, and a large amount of nonuniform glaring reflected light is observed.

D: A coated surface on which a huge amount of contrast between fine light and dark is observed, and a huge amount of nonuniform glaring reflected light is observed.

Evaluation on Marker Erasability

As a commercial whiteboard marker and an eraser, those manufactured by KOKUYO Co., Ltd are used to write on the coated surface. The coated surface is left for 1 day at room temperature. Thereafter, the remaining ink after erasing a writing area by moving the eraser back and forth 3 times is judged according to the following standards.

A: No stain

B: Slight stains

C: Half or more are erased

D: Half or more of ink remains

Evaluation on Durability with respect to Repetition of Writing with Marker and Erasing

As a commercial whiteboard marker and an eraser, those manufactured by KOKUYO Co., Ltd are used to write and erase with an eraser with a load of 500 g, and ink stains after 10,000 rotations of this operation are judged based on the following standards. As a device, a table top robot (manufactured by IAI Corporation) is used.

A: No stains, and a reduction in film thickness is 0.5 pm or less

B: Slight stains, or a reduction in film thickness exceeds 0.5 μm and 1 μm or less

C: Half or more are erased, or a reduction in film thickness exceeds 1 μm and less than 2 μm

D: Half or more of ink remain, or changes in film thickness are 2 μm or more

Evaluation on Erasability Over Time After Leaving Words Written with Marker at High Temperature

As a commercial whiteboard marker and an eraser, those manufactured by KOKUYO Co., Ltd are used to write on the coated surface. The coated surface is left for 8 hours at 60° C. Thereafter, the remaining ink after erasing a writing area by moving the eraser back and forth 10 times is judged according to the following standards.

A: No stain

B: Slight stains

C: Half or more are erased

D: Half or more of ink remains

Evaluation on Projector Projection Performance

A commercially available projector is used to project on the coated surface, and the glare caused by the irradiation light is judged according to the following standards.

A: Almost no irradiation light is checked

B: Irradiation light looks blurry, but no glare is seen

C: A little glare is seen

D: Greatly bright glare is seen

Measurement of Surface Glossiness of Coated Surface (60° Gloss)

The coated surface is measured at a measurement angle of 60° by using a surface gloss meter manufactured by BYK.

Measurement of Pencil Hardness of Coated Surface

The pencil hardness of the coated surface is measured by the method described in JIS K 5600-5-4.

Measurement of Smoothness (Ra and Wca) of Coated Surface

Using a surface roughness measuring instrument SURFCOM 130a (manufactured by TOKYO SEIMITSU CO., LTD.) , a center line average roughness Ra and a filtered center line waviness profile Wca of the coated surface are measured. Both show that as the number becomes smaller, the surface smoothness of the coated film becomes excellent.

Details of each of the examples and the evaluation results are collectively shown in Table 1.

TABLE 1

| | | | | | | | | | Durability | | |
|---|---|---|---|---|---|---|---|---|---|---|---|
| | | Amount of | Surface | | Smoothness | | | | with | | Projector |
| | Coating | metal ion | glossiness | Pencil | Ra | Wca | | Marker | respect to | Erasability | projection |
| | material | (% by mass) | ( ° ) | hardness | (μm) | (μm) | Moistness | erasability | repetition | over time | performance |
| Example 1 | PC1 | 0.78 | 45 | 3H | 0.49 | 0.51 | A | A | A | C | A |
| Example 2 | PC3 | 0.88 | 41 | 3H | 0.58 | 0.60 | A | A | A | C | A |
| Example 3 | PC5 | 0.88 | 38 | 3H | 0.82 | 0.91 | B | A | A | C | A |
| Example 4 | PC6 | 0.68 | 37 | 3H | 1.09 | 1.56 | B | B | A | C | B |
| Example 5 | PC7 | 0.76 | 45 | 3H | 0.50 | 0.52 | A | A | A | B | A |
| Example 6 | PC9 | 0.65 | 41 | 3H | 0.60 | 0.60 | A | B | A | C | A |
| Example 7 | PC11 | 0.38 | 48 | 3H | 0.55 | 0.65 | A | A | A | A | A |
| Example 8 | PC13 | 0.35 | 38 | 3H | 0.58 | 0.61 | A | A | A | A | A |
| Example 9 | PC15 | 0.39 | 48 | 3H | 0.54 | 0.62 | A | A | A | A | A |
| Example 10 | PC17 | 0.73 | 46 | 3H | 0.56 | 0.60 | A | A | A | B | A |
| Example 11 | PC2 | 0.50 | 85 | H | 0.06 | 0.10 | A | A | A | B | C |
| Example 12 | PC4 | 0.51 | 87 | H | 0.05 | 0.08 | A | A | A | B | C |
| Example 13 | PC8 | 0.50 | 88 | H | 0.06 | 0.08 | A | A | A | B | C |
| Example 14 | PC10 | 0.52 | 78 | 2H | 0.08 | 0.10 | A | A | A | C | C |
| Example 15 | PC12 | 0.40 | 45 | 3H | 0.60 | 0.60 | A | A | A | A | A |
| Example 16 | PC14 | 0.38 | 37 | 4H | 0.58 | 0.61 | A | A | A | A | A |
| Example 17 | PC16 | 0.42 | 46 | 3H | 0.54 | 0.63 | A | A | A | A | A |
| Example 18 | PC18 | 0.53 | 87 | 3H | 0.07 | 0.09 | A | A | A | A | C |
| Example 19 | PC23 | 0.45 | 44 | 4H | 0.50 | 0.58 | A | A | A | A | A |
| Comparative | PC19 | 0.01 | 40 | 2H | 0.89 | 0.96 | C | C | D | C | A |
| Example 1 | | | | | | | | | | | |
| Comparative | PC20 | 0.01 | 80 | 2H | 1.05 | 1.18 | D | C | D | C | D |
| Example 2 | | | | | | | | | | | |
| Comparative | PC21 | 0.01 | 40 | 2H | 1.65 | 1.88 | C | D | C | C | C |
| Example 3 | | | | | | | | | | | |
| Comparative | PC22 | 0.01 | 75 | 3H | 2.10 | 2.50 | C | D | C | D | C |
| Example 4 | | | | | | | | | | | |
| Comparative | LC1 | — | 95 | H | 0.05 | 0.07 | D | B | D | B | D |
| Example 5 | | | | | | | | | | | |
| Comparative | LC2 | — | 35 | H | 1.28 | 1.42 | D | D | D | D | C |
| Example 6 | | | | | | | | | | | |
| Comparative | LC3 | — | 87 | F | 0.12 | 0.18 | D | D | D | D | D |
| Example 7 | | | | | | | | | | | |
| Comparative | WH-200 of | — | 92 | — | — | — | D | A | A | C | D |
| Example 8 | 3M Company | | | | | | | | | | |
| Comparative | PWF-500 of | — | 25 | — | — | — | D | A | D | D | B |
| Example 9 | 3M Company | | | | | | | | | | |

Based on the results shown in Table 1, it is understood that the powder coating material of the present example is excellent in the moistness of the surface of the obtained coated film, as compared with the powder coating material of the comparative example.

Based on the results shown in Table 1, in a case where the powder coating material of the present example is used to form a writing surface of the writing board, the powder coating material of the present example is also excellent in the marker (specifically, a writing instrument for a white board) erasability, the erasability over time after leaving words written with a marker at high temperature, and the durability with respect to repetition of writing with a marker and erasing.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A powder coating material containing:
an acrylic resin that has a side chain having an alkyl group having 4 or more carbon atoms and a hydroxy group; and
a curing agent.

2. The powder coating material according to claim 1,
wherein the side chain has a hydroxyalkyl group having 3 or more carbon atoms as the hydroxy group.

3. The powder coating material according to claim 1,
wherein the hydroxy group in the side chain is a secondary or tertiary hydroxy group.

4. The powder coating material according to claim 1,
wherein the curing agent includes at least one compound selected from the group consisting of a blocked isocyanate compound, an epoxy compound, and an oxetane compound.

5. The powder coating material according to claim 4,
wherein the curing agent includes a blocked isocyanate compound.

6. The powder coating material according to claim 1, further containing:
a particle.

7. The powder coating material according to claim 6,
wherein the particle includes an inorganic particle.

8. The powder coating material according to claim 6,
wherein the particle includes an organic resin particle.

9. The powder coating material according to claim 8,
wherein the organic resin particle includes an organic resin particle that contains a gel component.

10. The powder coating material according to claim 8,
wherein the organic resin particle contains a crosslinked resin particle.

11. The powder coating material according to claim 1, further containing:
0.35 to 0.88% by mass of metal ions with respect to the entire powder particles.

12. A coated product comprising:
a layer that is formed by curing the powder coating material according to claim 1 on an outermost layer.

13. A writing board comprising:
a layer that is formed by curing the powder coating material according to claim 1 on an outermost layer.

14. The writing board according to claim 13, which is a projection writing board.
